(19) United States
(12) Patent Application Publication
(10) Pub. No.: US 2014/0195515 A1
(43) Pub. Date: Jul. 10, 2014

(54) METHODS AND SYSTEMS FOR QUERYING AND DISPLAYING DATA USING INTERACTIVE THREE-DIMENSIONAL REPRESENTATIONS

(71) Applicant: I3 ANALYTICS, Columbia, MD (US)

(72) Inventors: Kirk L. Baker, Columbia, MD (US); William D.A. Zerhouni, Columbia, MD (US); Robert Harriman, Columbia, MD (US); Archna Bhandari, Columbia, MD (US)

(73) Assignee: i3 Analytics, Columbia, MD (US)

(21) Appl. No.: 13/738,034

(22) Filed: Jan. 10, 2013

(51) Int. Cl. G06F 17/30

(52) U.S. Cl. CPC G06F 17/30554
USPC 707/722

(57) ABSTRACT

Methods and systems for querying data, and displaying the query results using an interactive representation in three spatial dimensions are disclosed. Query or search results are analyzed and displayed in an interactive three-dimensional representation using a plurality of nodes, representing aspects of the search results, and links connecting the nodes, representing strength of relation between the connected nodes. The inventive methods and systems allow users to manipulate the three-dimensional representation to view the search results from different angles. The inventive methods and systems also allow users to activate sub-applications from any node, to filter or browse data results, and/or to update all nodes linked to any activated node.

### FIELD OF THE INVENTION

The present invention generally relates to the field of information retrieval and data display and visualization. More particularly, the invention relates to systems and methods for searching and displaying information and data results wherein the searching may involve querying one or more data bases in parallel or sequence, analyzing and visualizing data search results and relationships using an interactive three-dimensional representation where the appearance and content of the search results may be based on criteria specified by a user.

### BACKGROUND OF THE INVENTION

Computerized information retrieval systems use software programs designed to search for electronic information based on user queries, and designed to return to the user, the information and data results that relate to the user queries. Many such software programs and systems exist and are in use today. While most of the existing search and retrieval systems are able to return a large number of search results at a “hit” or record level, such system are not capable of and do not display any relations or connections between the “hits,” records or data sets. Users are therefore often compelled to conduct multiple searches, using multiple systems, and multiple data sets, and then retrieve the multiple search results, and compile and aggregate the results offline before conducting analyses relating to the search results. Furthermore, data visualizations are typically not integrated into current system retrieval processes, and users are often overwhelmed with the information retrieved for any given query or search request.

Accordingly, the need exists for a method and systems for searching and retrieving information and records from a plurality of data sources, and displaying and visualizing the relationships between records and data sources. Moreover, the method and systems should incorporate the flexibility for user customizable search and filtering parameters to update and refine the search results and display results.

Further, for the limited current information retrieval systems that may provide for display and visualization of data results, are predominantly limited to two spatial dimensions. Such two-dimension displays and visualizations are often very cluttered and difficult to analyze and navigate. Indeed, with respect to current systems and methods, users are not able to easily access and interpret information using such two-dimensional displays or visualizations. Therefore, the need also exists for systems and methods to display retrieved data and data relationships in three dimensions, with such systems and methods being capable of providing an interactive data visualization model with nodes and nodal links, wherein the model responds to user input for view commands such as rotating or zooming, and query commands such as searching, browsing, or filtering data.

### SUMMARY OF THE INVENTION

The present invention overcomes the disadvantages of the prior art and fulfills the needs described noted above by providing a method for searching and retrieving records based on user customizable search and filtering parameters, and displaying records and search results using relationships between records and data sets in an interactive three-dimensional representation.

More specifically, a preferred embodiment of the present invention is a method for searching at least one data source, and displaying the results of the search using a computer processor, the method comprising the steps of (a) selecting at least one data source to be searched; (b) entering at least one search term to be used in the search; (c) processing the search of said at least one data source using said at least one search term; (d) identifying the data sources that contain a plurality of hits for said search term; and (e) displaying said hits and search results in a three-dimensional graphical representation using a plurality of nodes and interconnecting links; wherein said plurality of nodes represent said at least one data source, and said interconnecting links graphically connect said plurality of nodes.

Another preferred embodiment of the present invention is a method for searching at least one data source, and displaying the results of the search using a computer processor, the method comprising the steps of (a) selecting at least one data source to be searched; (b) entering at least one search term to be used in the search; (c) processing the search of said at least one data source using said at least one search term; (d) identifying the data sources that contain a plurality of hits for said search term; and (e) displaying said hits and search results in a three-dimensional graphical representation using a plurality of nodes and interconnecting links; (f) selecting one of said plurality of nodes within said three-dimensional representation; (g) displaying a sub-application menu for said selected one of said plurality of nodes; (h) entering at least one filter parameters related to selected one of said plurality of nodes; and (i) updating the search results for all nodes linked to said selected one of said plurality of notes, based upon the entered at least one filter parameters, wherein said plurality of nodes represent said at least one data source, and said interconnecting links graphically connect said plurality of nodes.

A further preferred embodiment of the present invention is a method for searching at least one data source, and displaying the results of the search using a computer processor, the method comprising the steps of (a) selecting at least one data source to be searched; (b) entering at least one search term to be used in the search; (c) processing the search of said at least one data source using said at least one search term; (d) identifying the data sources that contain a plurality of hits for said search term; and (e) displaying said hits and search results in a three-dimensional graphical representation using a plurality of nodes and interconnecting links; wherein said plurality of nodes represent said at least one data source, and said interconnecting links graphically connect said plurality of nodes, and further wherein the display size of each of said plurality of nodes is proportional to the number of hits within said at least one data source, and color shading of each of said plurality of nodes is a function of relevance of said hits, and/or wherein color shading of each of said plurality of nodes is a function of relevance of said hits, and/or wherein thickness of the interconnecting links between any two nodes in the three-dimensional representation is a function of the search results for the number of results links between said two nodes.

The present invention also includes a computerized system for electronically searching at least one data source, and displaying the results of said search, comprising a plurality of computer processors communicatively linked to a plurality of users; a plurality of memory for storing data, said plurality of memory being communicatively coupled to said at least one of said plurality of computer processors; a computer-readable storage medium storing a software program with said software program implemented to perform the method steps of: (a) selecting at least one data source to be searched; (b) entering at least one search term to be used in the search; (c) processing the search of said at least one data source using said at least one search term; (d) identifying the data sources that contain a plurality of hits for said search term; and (e) displaying said hits and search results in a three-dimensional graphical representation using a plurality of nodes and interconnecting links, wherein said plurality of nodes represent said at least one data source, and said interconnecting links graphically connect said plurality of nodes.

The present invention further includes a system for implementing the above methods in a client-server architecture by providing a plurality of servers that are communicatively linked to a plurality of clients via a network. The software implementing the above methods is stored in a computer-readable storage medium provided in the plurality of servers.

Further, the present invention includes a system for implementing the above methods using a cloud computing architecture. The software implementing the methods is stored in an application server in the cloud, and a plurality of clients and data sources are communicatively linked to the cloud.

Other features and advantages of the present invention are described in the following detailed description of the invention, which refers to the accompanying drawings as described herein.

### BRIEF DESCRIPTION OF THE DRAWINGS

FIG. 1A shows an example block diagram of a method in accordance with an embodiment of the present invention;

FIG. 1B shows another example block diagram of a method in accordance with another embodiment of the present invention;

FIG. 2 illustrates a search page interface used to implement methods in accordance with an embodiment of the present invention;

FIGS. 3A through 3D illustrate four example results pages showing varied views of a three-dimensional data results in accordance with an embodiment of the present invention;

FIG. 4 illustrates a results page interface used to implement methods in accordance with another embodiment of the present invention showing the effect of frequency of nodal hits;

FIGS. 5A through 5D illustrate a sub-application page interface used to implement methods in accordance with an embodiment of the present invention;

FIGS. 6A through 6C illustrate a sub-application page interface used to implement methods in accordance with another embodiment of the present invention;

FIG. 7 shows an example block diagram of a method in accordance with another embodiment of the present inventive data retrieval and display methods where the user enters search parameters for the data sources;

FIG. 8A through 8H illustrate examples of a search page interface, a sub-application page interface, and a results page interface, as used to implement methods in accordance with an embodiment of the present inventive data retrieval and display methods where the user enters search parameters for the data sources;

FIG. 9 illustrates an example results page interface showing a visual relationship between data sources in accordance with an embodiment of the present invention;

FIG. 10 shows a system hierarchy chart in which methods according to various embodiments of the invention may be implemented;

FIG. 11 is schematic diagram of an exemplary system in which methods according to various embodiments of the invention may be implemented;

FIG. 12 is a schematic diagram of a further exemplary system in which methods according to various embodiments of the invention may be implemented; and

FIG. 13 are schematic diagrams of a still further exemplary system in which methods according to various embodiments of the invention may be implemented.

### DETAILED DESCRIPTION OF PREFERRED EMBODIMENTS

The disclosed embodiments of the present invention relate to methods for searching one or more data sets, and displaying, visualizing, browsing and manipulating the data search results in a three-dimensional representation. The disclosed embodiments of the present invention further relate to systems for implementing the inventive data search, retrieval, and display methods. The following terms as may be used in this specification are defined and provided for convenience, and are not to be viewed as improperly or inappropriately limited the meaning of particular terms.

The term “relevance” or “relevant” is defined as how well a retrieved result meets the information needs of the user; or is defined as a measure of how closely a given object (file, web page, database record, etc.) matches a user's search for information.

The term “hit” is defined as an item that is located in and/or retrieved from a data base, data source or data set in direct or indirect response to a query.

The term “mobile device” also referred to as a “handheld device.” A handheld device is intended to include any electronic or computing device that may be held in a hand. Such handheld devices include, but are not limited to, personal digital assistants (“PDA”); smartphones such as Apple's iPhone, Samsung's Droid and Blackberry Storm; tablet computers such as Apple's iPad, Motorola's Xoom, BlackBerry PlayBook, Microsoft's Surface, and Samsung's Galaxy Tab; a mobile internet device (“MID”) such as Lenovo's Ideapad; Nokia's N810; and similar cellular phones.

The term “cloud computing” is defined as a model for enabling convenient, on-demand network access to a shared pool of configurable computing resources (such as networks, servers, information storage, applications, and related services) that can be rapidly provisioned and released with minimal management effort or service provider interaction. See http://www.nist.gov/itl/cloud/. Cloud computing also refers to any system providing access via the Internet to processing power, data storage, software or other computing services, often accessed via a web browser.

The term “computer-readable storage medium” or “computer-readable storage media” is intended to include any medium or media capable of storing data in a machine-readable format that can be accessed by a sensing device and capable of converting the data into binary format. Examples include, but not limited to, floppy disks, hard drives, zip disks, tape drives, CD-ROMs CD-Rs, CD-RWs, DVD-ROMs, DVD-RWs, blu-ray discs USB flash drives, RAM, ROM, solid state drives, memory sticks, multimedia cards, CompactFlash cards, holographic data storage devices, minidiscs, semiconductor memory or storage devices, or other similar devices existing or to be created.

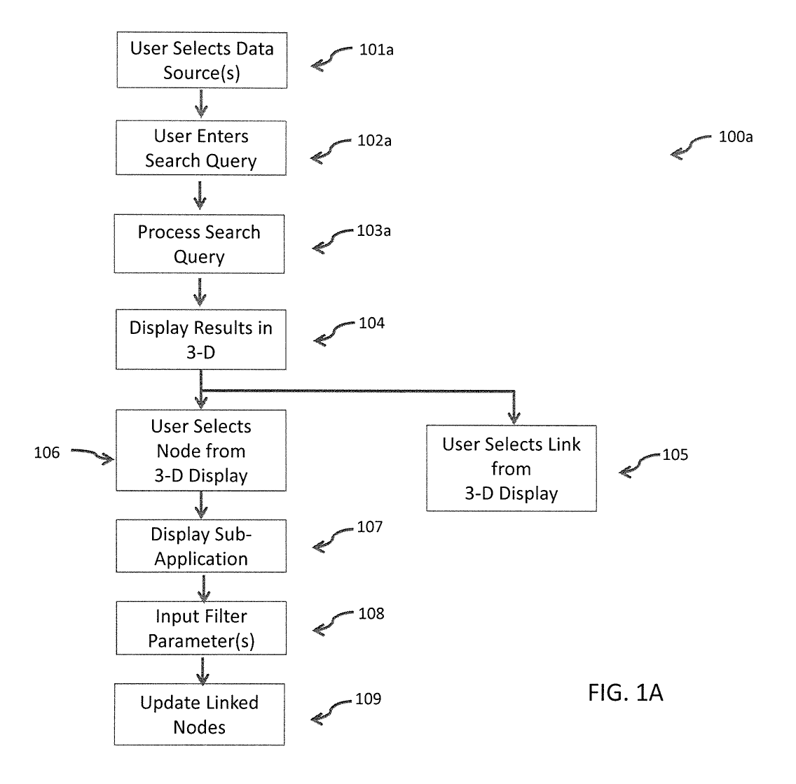

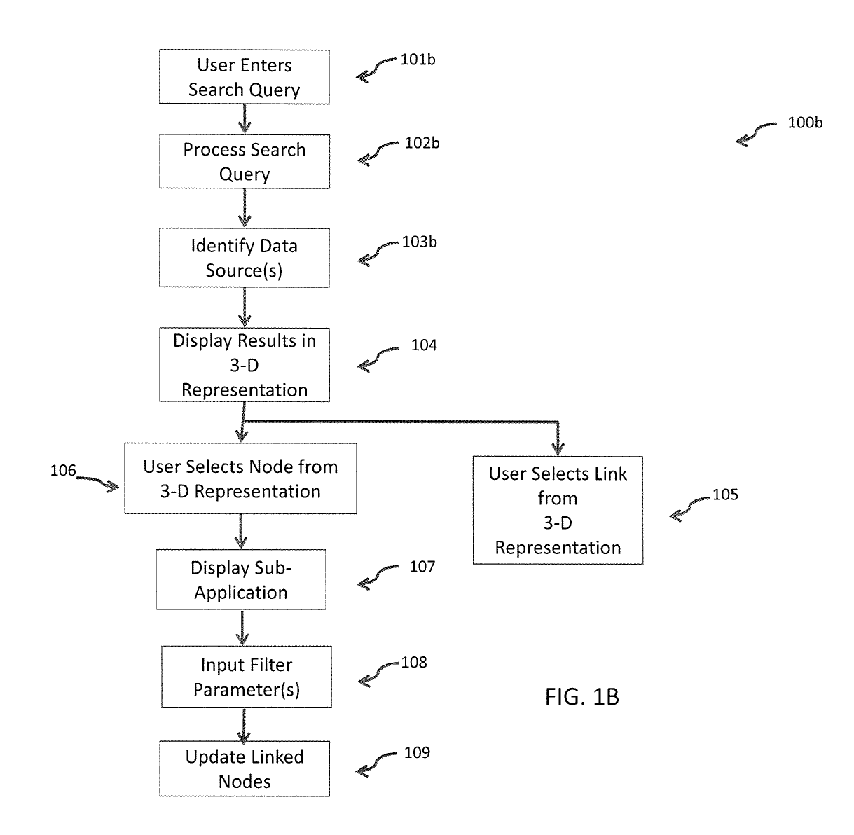

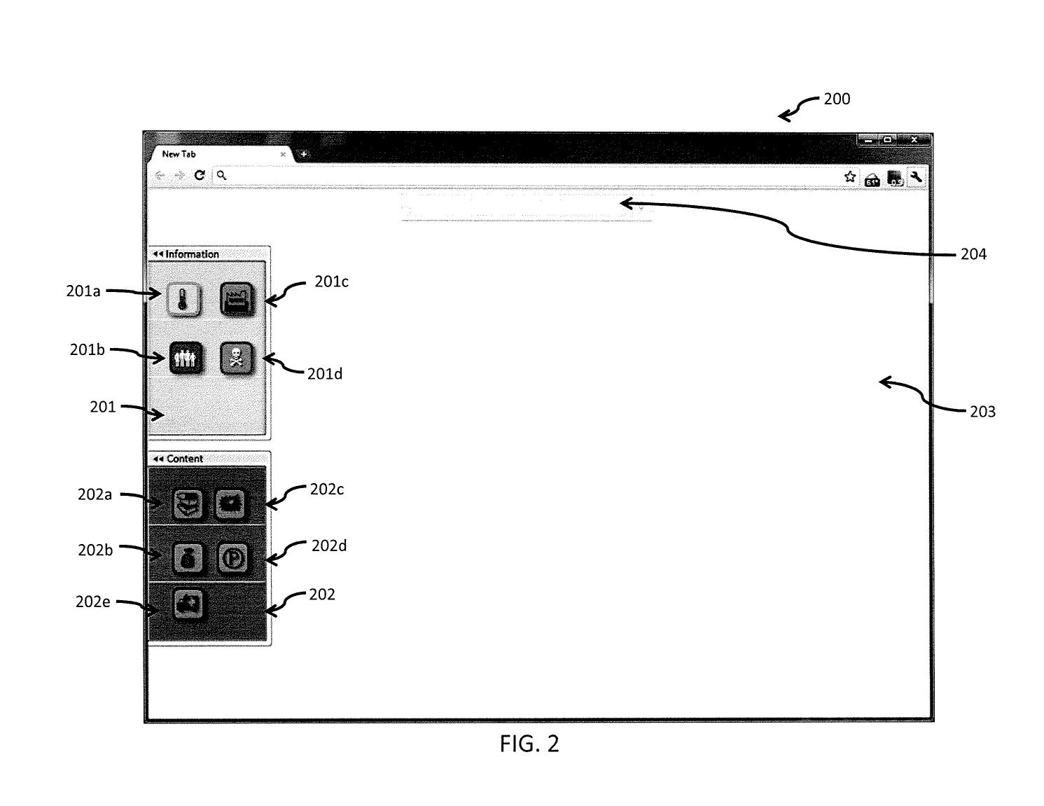

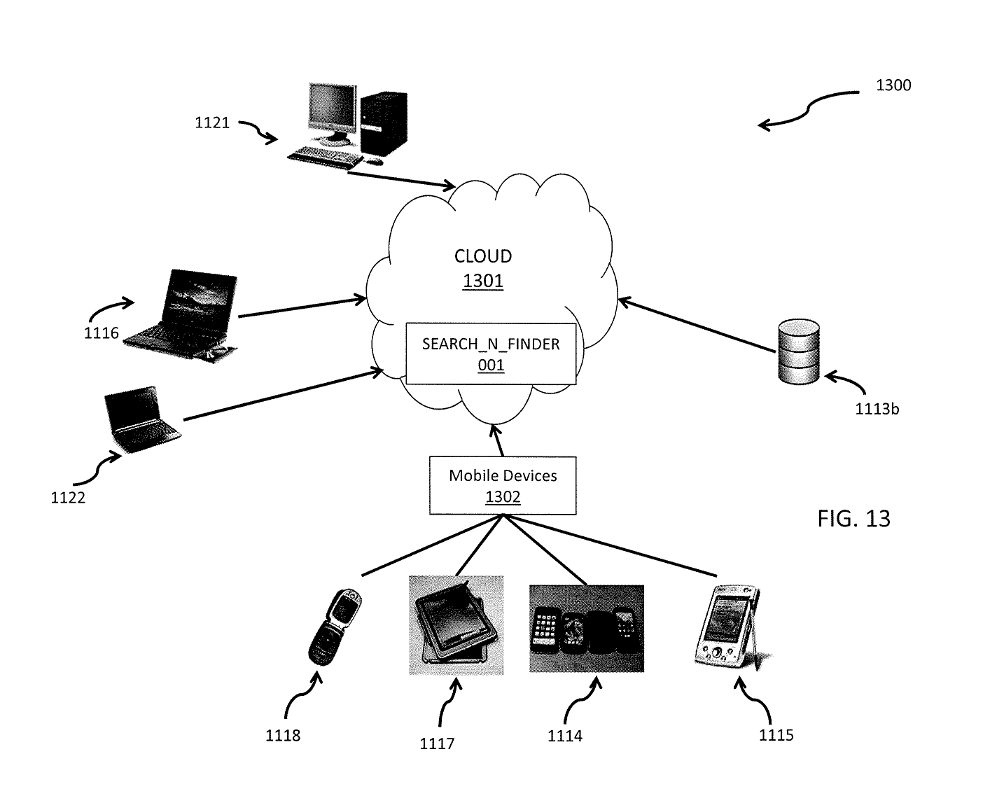

Referring now to the attached drawings, where like elements are designated by like reference numerals, FIG. 1A shows a flowchart of an exemplary embodiment of a method 100a for searching, displaying and visualizing data obtained from one or more data sources. In one preferred embodiment, the inventive methodology may be implemented through a software application and system, illustrated in FIG. 13 as maintained in the cloud 1301 as “Search_N_Finder” 001. The cloud 1301 version of the system and program may be communicatively linked, in real-time or otherwise, to content data sources, as illustrated in FIG. 2, and labeled as 202a, 202b, 202c, 202d, and 202e, and/or to entity data sources, again as illustrated in FIG. 2, and labeled as 201a, 201b, 201c, and 201d.

In step 101a of the method shown in FIG. 1A, the user may select a plurality of disparate data sources, including by way of example those illustrated in FIG. 2 as 201a, 201b, 201c, 201d, 202a, 202b, 202c, 202d, and 202e. By way of example, such data sources could relate to pharmaceuticals, companies, people, diseases/conditions, publications and guidelines, grants, news, patents and/or electronic health records. These disparate data sources 201a, 201b, 201c, 201d, 202a, 202b, 202c, 202d, and 202e may include, again by way of example only, but not be limited to, National Library of Medicine's (“NLM”) Medline®, the National Institute of Health and Sciences (“NIH”)'s awarded grants, the American Association of Cancer Research's (“AACR”) conference proceedings, clinicaltrials.gov, RSS feeds, or other similar proprietary databases.

In step 102a, the user next enters a relevant search term using free text query in a search query textbox 204 (as illustrated in FIG. 2) and activates a “search” button. The software application 001 then processes the search query and identifies all data sources that contain one or more hits for the search term, in step 103. In step 104, the data sources containing hits are displayed in a three-dimensional representation having a plurality of nodes and links. In a preferred embodiment, the nodes of the three-dimensional representation may each represent a data source, a data filter or a browsing application. The links connect the plurality of nodes and represent relationships between the connected nodes.

In step 106, the user may select a node in the three-dimensional representation and, as a result of that selection, in step 107, a sub-application is displayed to the user. The user may input filter parameters for the selected node in the sub-application as shown in step 108. The software application 001 then updates all nodes linked to the selected node, step 109, based upon the filter parameters entered in step 108. Alternatively, as shown in step 105, the user may select a link (instead of a node) in the three-dimensional representation.

In another preferred embodiment of the inventive methodology, as shown in FIG. 1B, a method 100b for searching, displaying, and visualizing data obtained from one or more data sources is shown. In step 101b, the user inputs a search term using free text query in a search query textbox 204 (as illustrated in FIG. 2) and activates a “search” button. Similar to the process described in FIG. 1A, the software application 001 then processes the search query, in step 102b. In step 103b, the software application 001 identifies the data sources that contain one or more hits for the search term entered by the user. The search results are then displayed, as shown in step 104, in a three-dimensional representation using a plurality of nodes and links. As described above, in a preferred embodiment, the nodes of the three-dimensional representation may each represent a data source, a data filter or a browsing application, and the links connect the plurality of nodes and represent relationships between the connected nodes.

In step 106, the user may select a node in the three-dimensional representation and in step 107, a sub-application is then displayed to the user. The user may input desired filter parameters for the selected node in the sub-application, as shown in step 108. The software application 001 then updates the search results for all nodes linked to the selected node, as shown in step 109. Alternatively, as shown in step 105, the user may select a link (instead of a node) in the three-dimensional representation to determine the particular linking relationship between nodes shown at either end of the link selected.

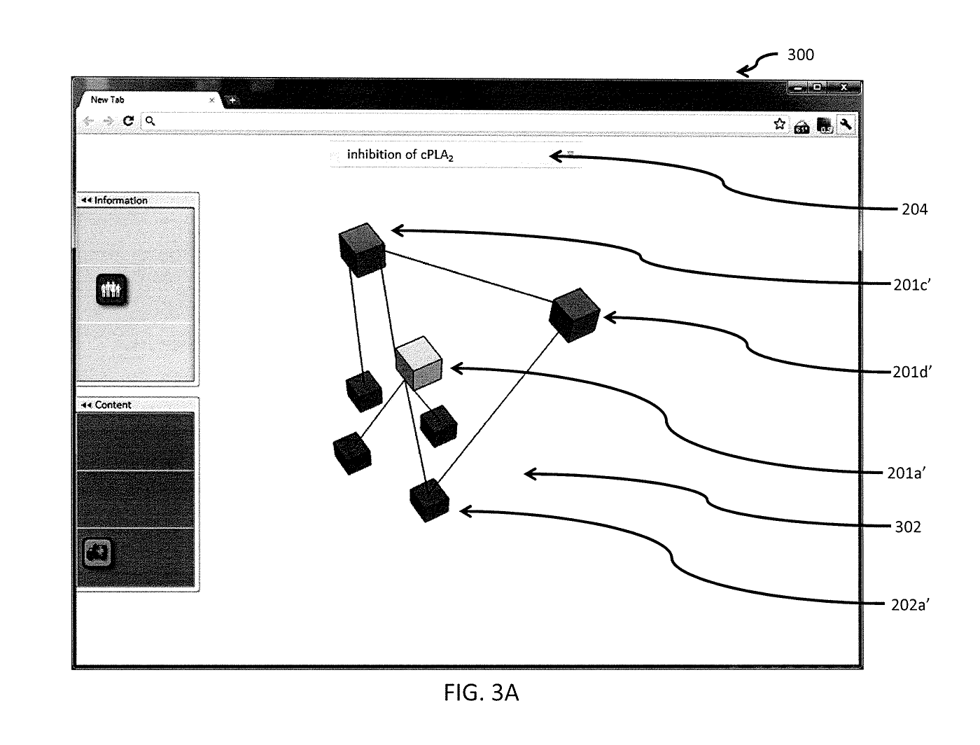

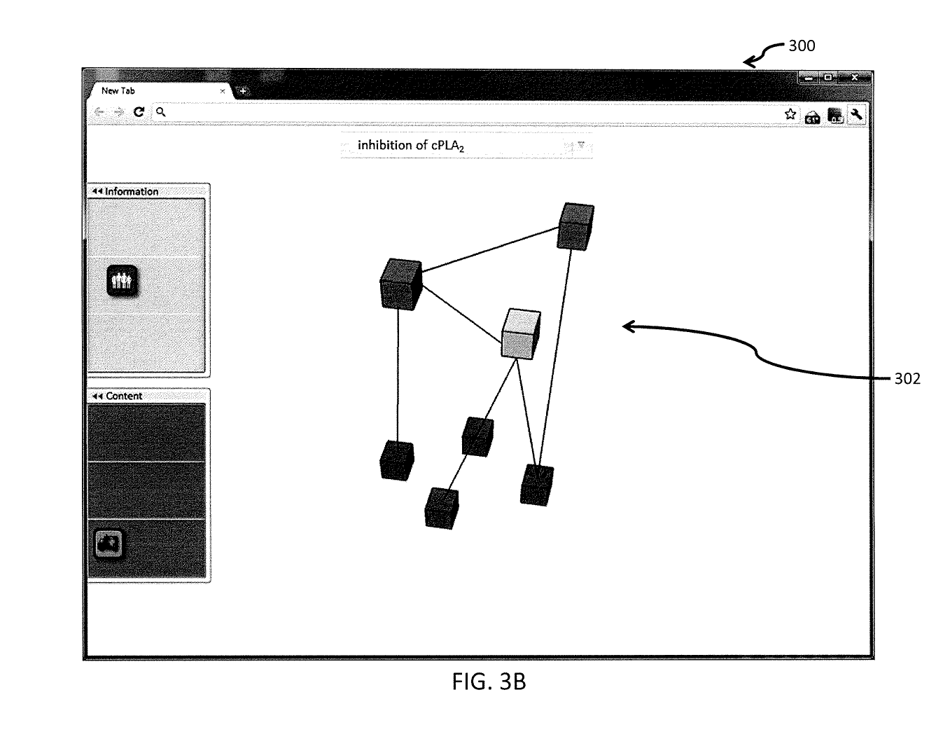

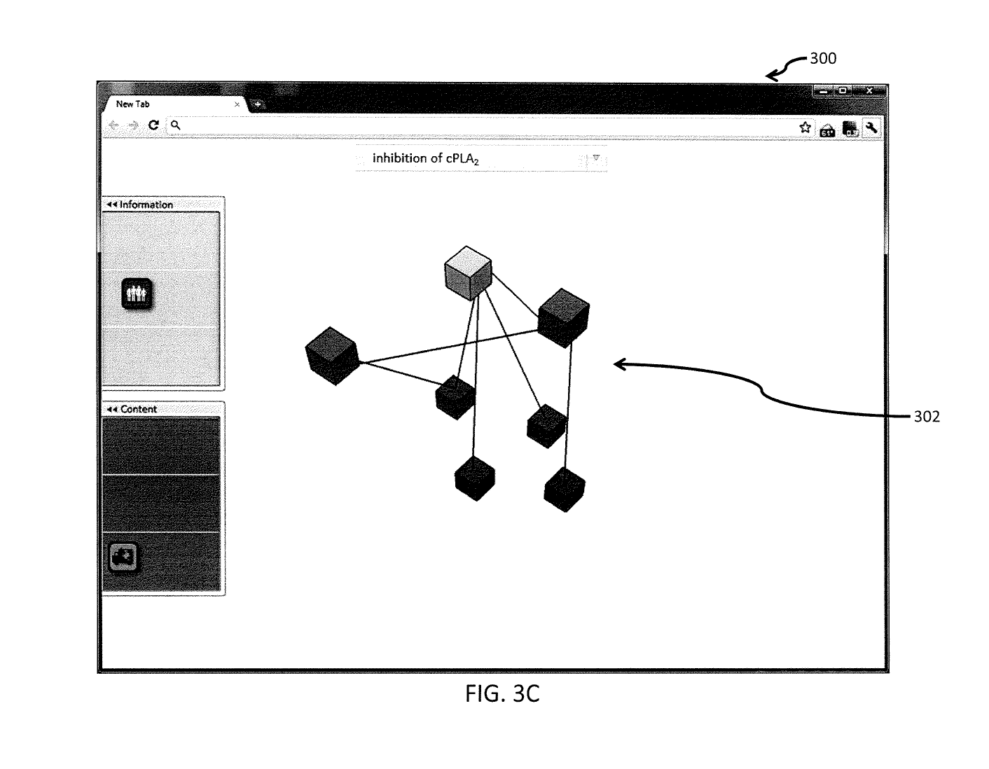

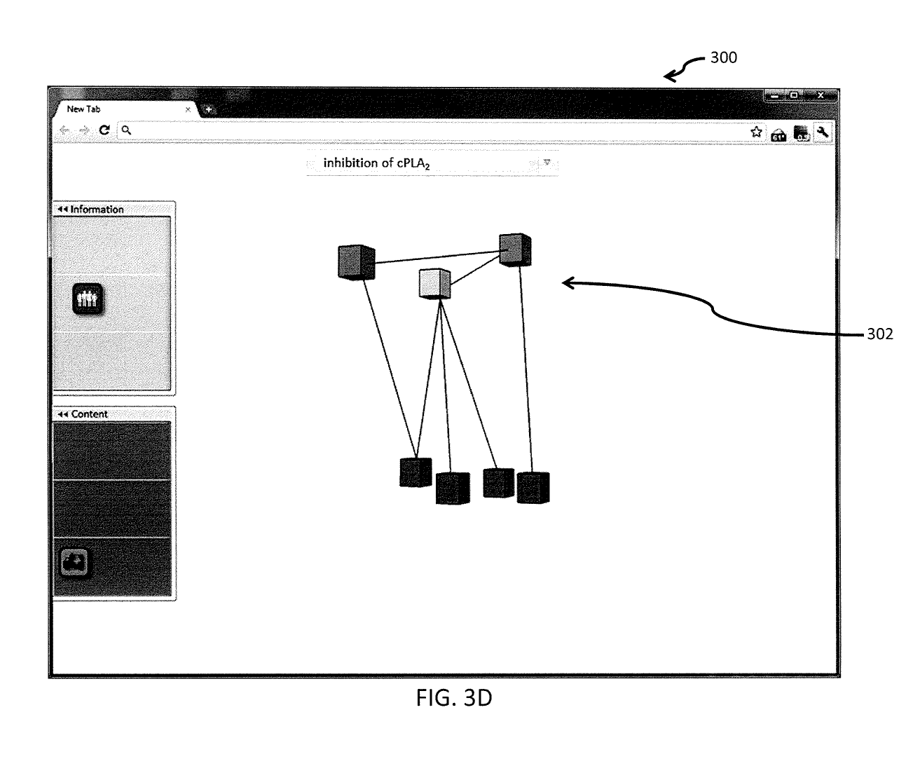

Referring to FIG. 2, and FIGS. 3A through 3D, a user may first specify a search term to retrieve and visualize data. For example as shown in FIG. 2, a search page interface 200 may have a search query textbox 204, an Information palette 201, a Content palette 202, and a Workspace 203. The Information palette 201 may have a plurality of data sources, for example as shown in FIG. 2, Drugs 201a, People 201b, Companies 201c, and Diseases/Conditions 201d. The Content palette 202 may have a plurality of data sources, for example as shown in FIG. 2, Medline 202a, Grants 202b, News 202c, Patents 202d, and Electronic Health Records 202e. To initiate a data search, a user may input a search term using free text query in the search query textbox 204 and activate the “search” button.

Referring to FIG. 3A, an exemplary results page 300 is shown for the search term “inhibition of cPLA₂” entered by a user in the search query textbox 204. The results page 300 displays a three-dimensional representation 302 of the search results in the workspace 203. The data sources that contain hits for the search term “inhibition of cPLA₂” move out of the Information palette 201 or the Content palette 202 and into the workspace 203. For example, the search term “inhibition of cPLA₂” resulted in hits in data sources Drugs 201a, Companies 201c, Disease/Condition 201d, Medline 202a, Grants 202b, News 202c, and Patents 202d. Data sources that do not contain any hits for the search term remain in the palettes. For example as shown in FIG. 3A, the data sources People 201b, and Electronic Health Record 202e remained in the Information palette 201 and the Content palette 202, respectively, for the search term “inhibition of cPLA₂.”

The search results for the search term are displayed in three dimensions using an interactive three-dimensional representation 302 and using links and nodes. The user can rotate, pan, zoom or flip the three-dimensional representation 302 to view the search results from different angles, as shown in FIGS. 3B through 3D. By manipulating the three-dimensional representation 302, as shown in FIGS. 3B through 3D, the user is easily able to interpret and understand the relationships between the nodes and search results. As noted above, each of the nodes of the three-dimensional representation 302 may serve as a data source, a data filter or a browsing application. Users may access any of the nodes or the links of the three-dimensional representation 302 to view detailed information about the selected node or link.

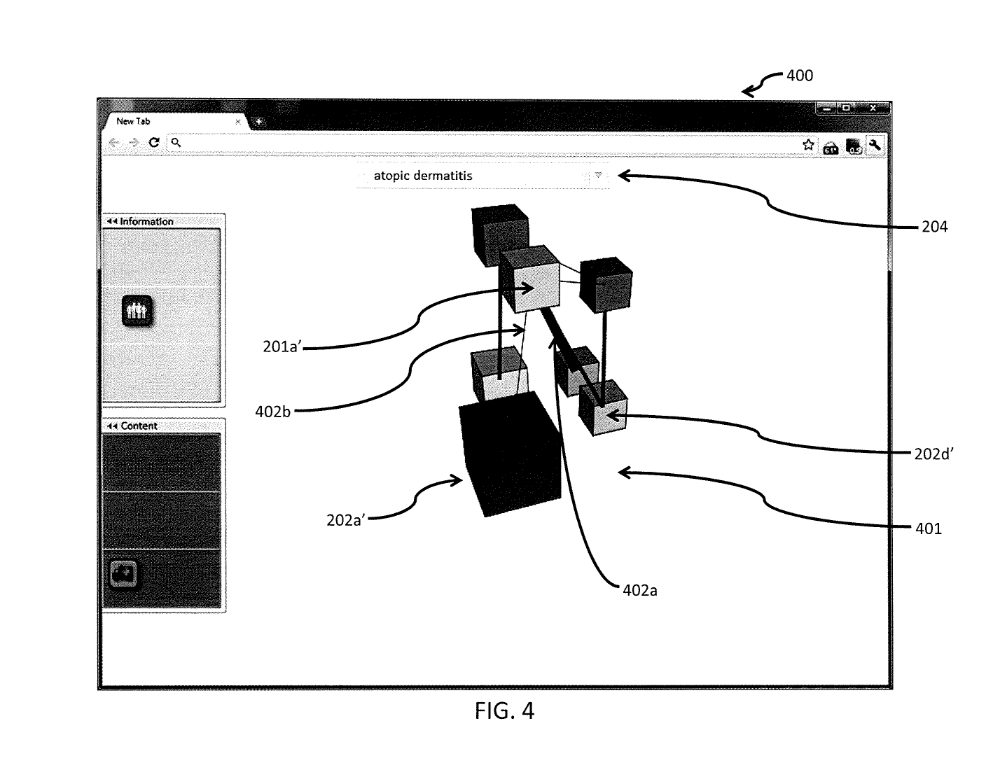

In another preferred embodiment, as shown in FIG. 4, a results page 400 is shown for the search term “atopic dermatitis” entered by a user in the search query textbox 204. The results page 400 again displays a three-dimensional representation 401 in the workspace 203. In this preferred embodiment of the inventive methodology, the size of a particular node in the three-dimensional representation 401 is related to the number of hits found in the underlying data source (e.g., node) for the search term entered. In a further preferred embodiment of the methodology and system, color shading of a node may be use to graphically show to the relevance of the hits to a search term within the data source.

Moreover, the thickness of the links connecting the nodes, as shown in FIG. 4, may be varied to corresponds to the number or nature of the links between data sources. For example, the data source Medline 202a, in comparison to other data sources, had the most hits and the most relevant hits for the search term “atopic dermatitis” and hence, the Medline data source node 202a′ is bigger in size and darker in color than the other nodes. Also, the link 402a is thicker than link 402b indicating a stronger relationship between data sources Drugs 201a and Patents 202d than between data sources Drugs 201a and Medline 202a.

Although the nodes in the three-dimensional representations 302, 401 are shown as cubes, it must be understood that any three-dimensional shape may be used to represent the nodes, including spheres or pyramids. Moreover, in another preferred embodiment, different node shapes could be use to graphically differentiate between data sources or data source types. Similarly, although the links are shown, in the exemplary representations 302, 401, as lines with varying thickness, it must be understood that any geometric shape may be used to represent similar characteristics, including without limitation dashed lines, wavy lines, or other connectors.

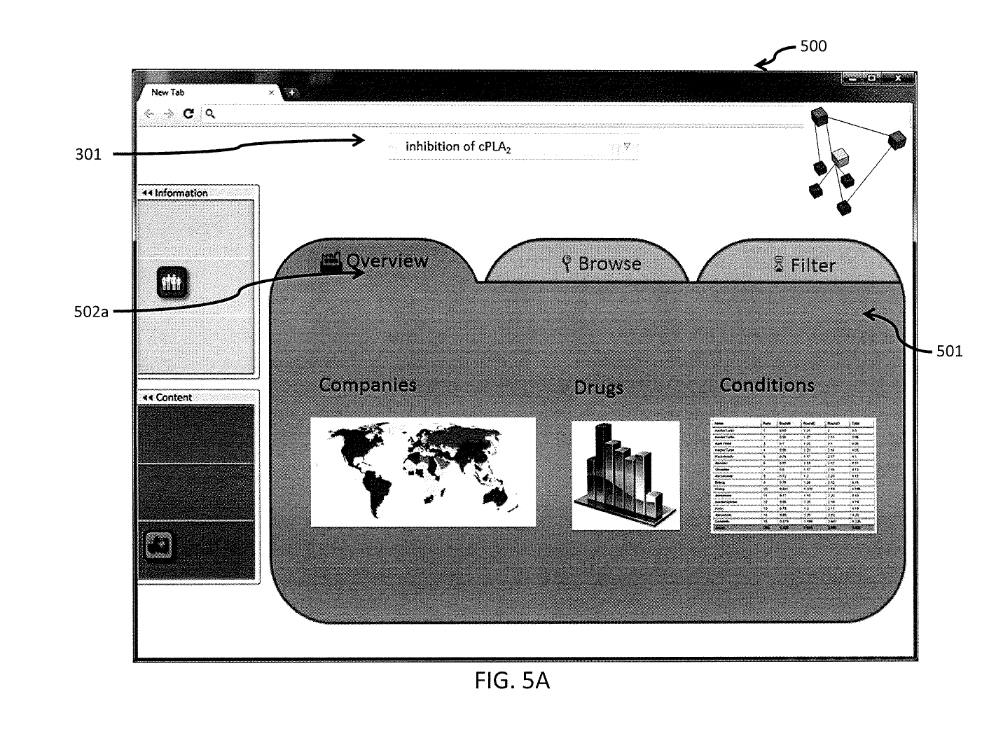

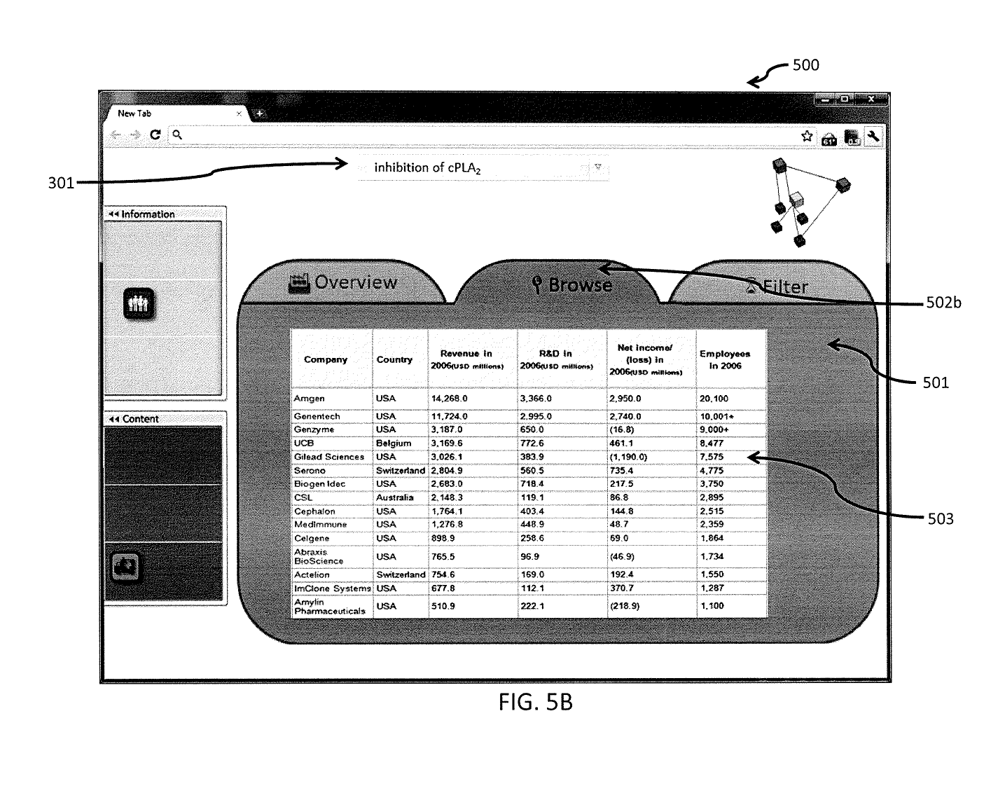

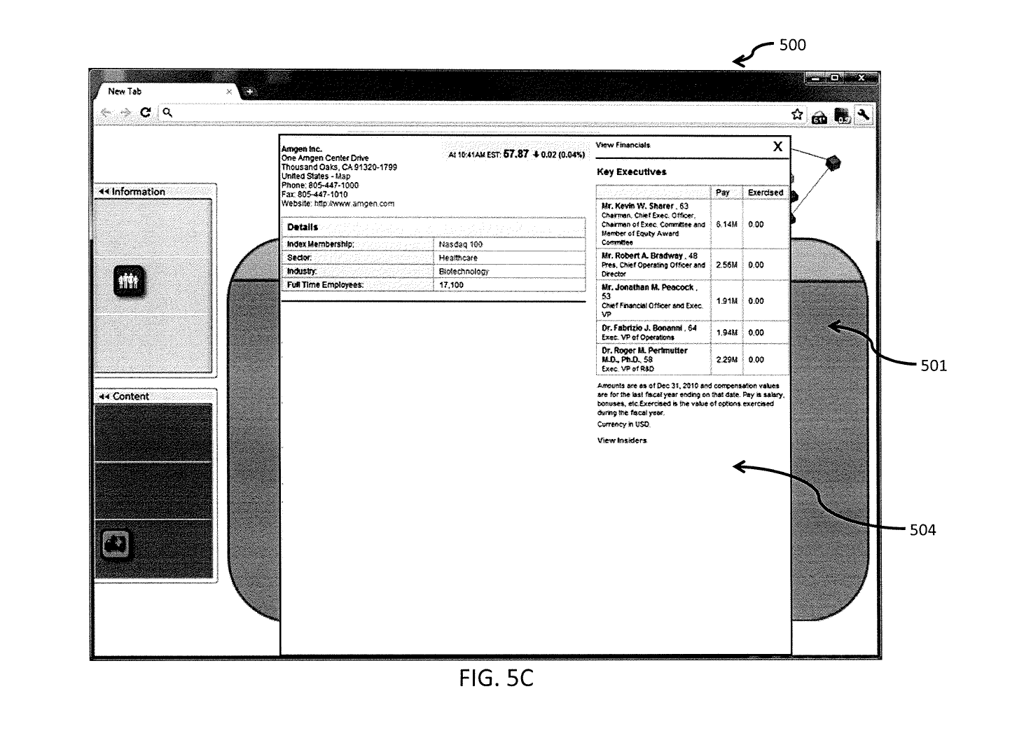

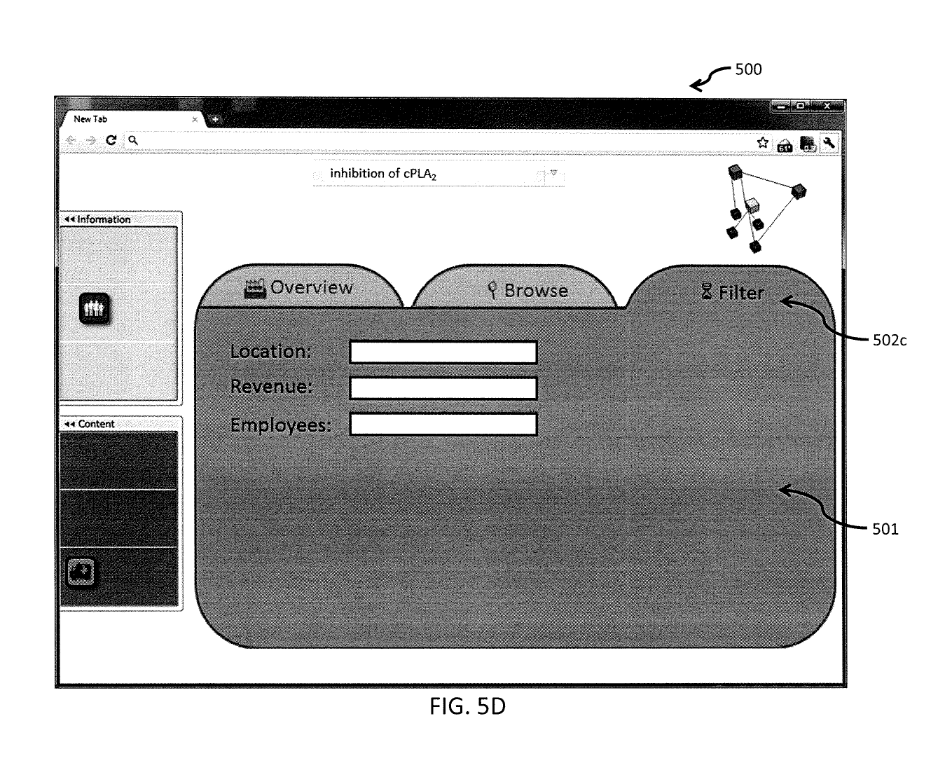

Users may access any of the data source nodes 201a′, 201c′, 201d′ of the three-dimensional representation 302 to view detail information by clicking on any of those data source nodes. Referring particularly to FIGS. 5A through 5D, a user may choose to access information available within the Companies data source node 201c′ displayed on the results page 300, shown in FIGS. 3A through 3D. Upon selecting the Companies data source node 201c′, a sub-application 501 is displayed on a sub-application page interface 500, as shown in FIG. 5A. In a preferred embodiment, the sub-application page has three tabs—Overview 502a, Browse 502b (FIG. 5B), and Filter 502c (FIG. 5D)—that provide the user with additional tools for data browsing and filtering. More particularly, the sub-application 501 helps the user to browse and filter data contained within that data source.

The Overview tab 502a displays a results summary including the nodes that are linked to it. For example, the results summary of the Companies data source node 201c′ for the search term “inhibition of cPLA₂” includes companies, drugs and conditions, as shown in FIG. 5A. Referring to FIG. 5B, the Browse tab 502b displays a search results table 503 listing including, for example, the company name, country of incorporation, revenue, R&D investment, net income and number of employees. The user may access further information on a given company by clicking the company's name in the search results table 503, which displays the company related information 504, as shown in FIG. 5C.

In a preferred embodiment, the user also has an option to specify filter parameters for each data source. Applying a set of filters to a particular node allows the user to selectively update any node that is linked to the selected node. Referring to FIG. 5D, the user may click on the filter tab 502c of the sub-application 501, and may then specify certain filter parameters such as location, revenue, or employees for the Companies data source node 201c′.

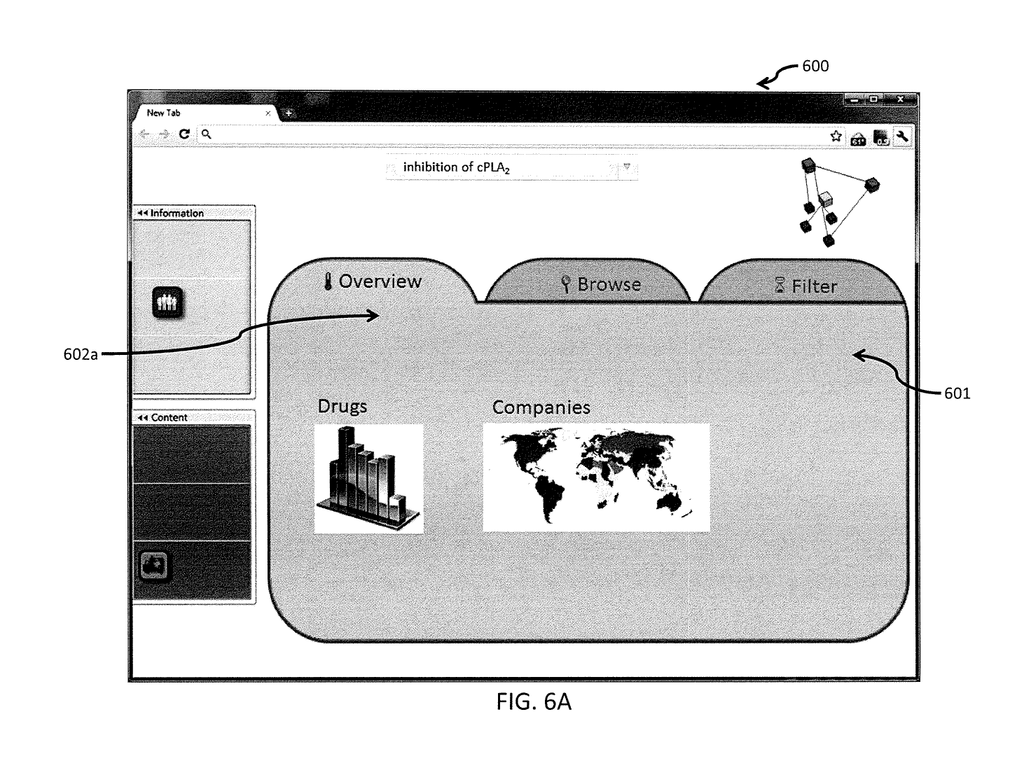

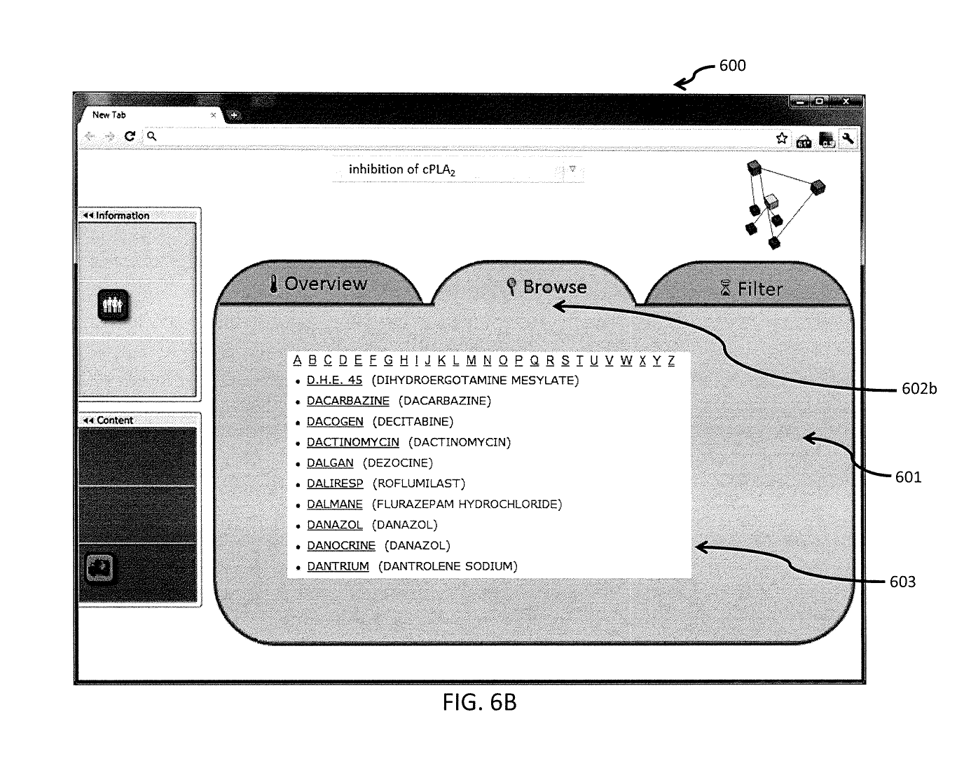

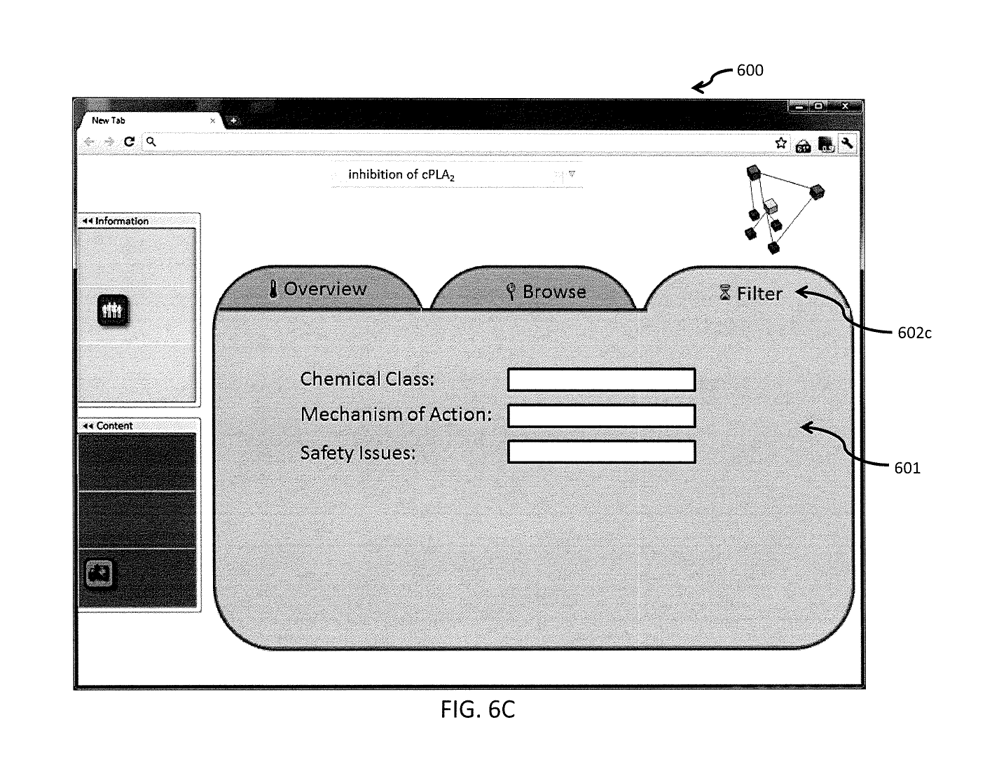

By way of example to illustrate access to another sub-application, and referring to FIGS. 6A through 6C, a user may choose to access information available within the Drugs data source node 201a′ displayed on the results page 300, and shown in FIGS. 3A through 3D. Upon selecting the Drugs data source node 201a′, a sub-application 601, shown in FIGS. 6A through 6C, is displayed on a sub-application page interface 600. In this preferred embodiment, the sub-application 601 has three tabs—Overview 602a (FIG. 6A), Browse 602b (FIG. 6B), and Filter 502c (FIG. 6C).

The Overview 602a tab displays a results summary including the nodes that are linked to it. For example, the results summary of the Drugs data source node 201a′ for the search term “inhibition of cPLA₂” includes results summary of the companies and drugs, as shown in FIG. 6A. Referring to FIG. 6B, the Browse 602b tab displays a search results table 603 listing, for example, the drugs in alphabetical order. The user also has the option to specify filter parameters for the Drugs data source node 201a′, for example, chemical class, mechanism of action or safety issues, as shown in FIG. 6C.

The exemplary software application 001 may be written in a procedural or object-oriented language. In a preferred embodiment, the software application 001 may be an interactive python-based computer generated imagery (“CGI”) web application that queries up to nine (9) data sources with some of the data sources being linked to one another. User's search query and data source selections are processed, and search results are returned via an HTML page that contains an interactive three-dimensional representation of selected data sources showing the links between the data sources. The three-dimensional representation is displayed in scalable vector graphics (“SVG”) using a Javascript library (e.g., svgml3d) that handles 3-D rendering of primitives. The search and retrieval functionality may be implemented as a free-text search engine or as structured database queries.

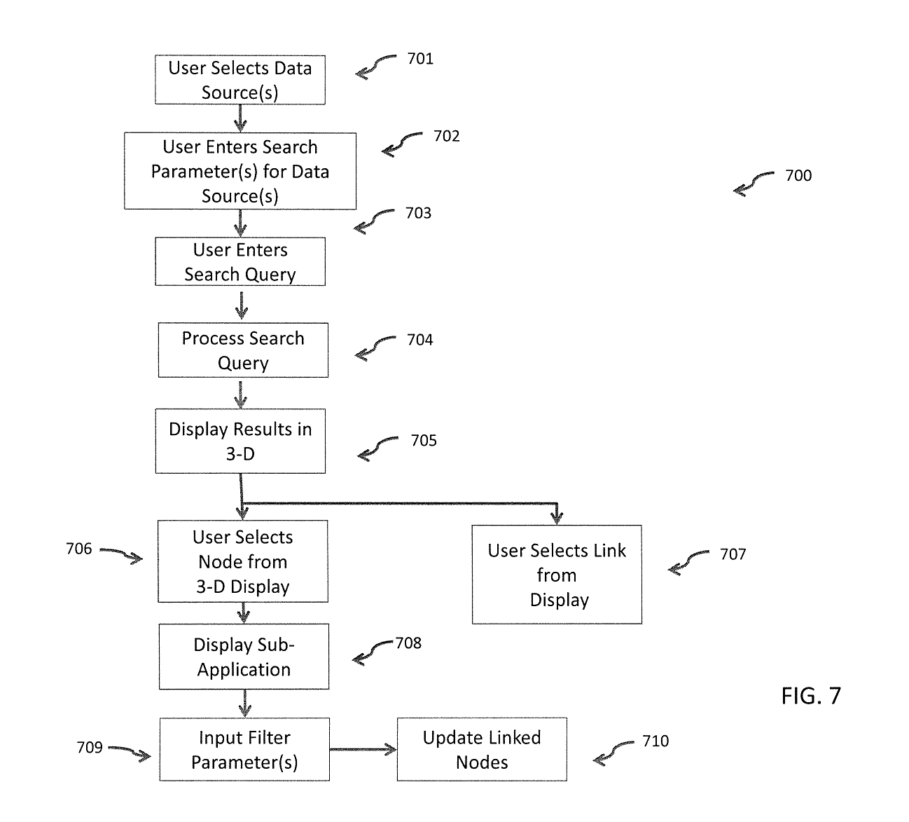

FIG. 7 illustrates a method 700 for searching, displaying, and visualizing data related to experts in accordance with another embodiment of the invention. For this embodiment, the user first logins to the software application 001 which is communicatively linked, in real-time or otherwise, to content data sources 202a, 202b, 202c, 202d, 202e and/or entity data sources 201a, 201b, 201c, 201d.

In step 701, the user selects a plurality of disparate data sources 201b, 202a, 202b, 202c, 202d such as people, publications and guidelines, grants, news, and patents. These disparate data sources 201b 202a, 202b, 202c, 202d may include, but not be limited to, National Library of Medicine's (“NLM”) Medline®, the National Institute of Health and Sciences (“NIH”)'s awarded grants, and the American Association of Cancer Research's (“AACR”) conference proceedings.

In step 702, the user inputs search parameter(s) for one or more of the plurality of data sources selected in step 701. The user then inputs a search term using free text query in a search query textbox 204 and activates a “search” button, in step 703. The software application 001 then processes, in step 704, the search query and identifies all data sources that contain one or more hits for the entered search term.

In step 705, the data sources containing hits are displayed in a three-dimensional representation having a plurality of nodes and links. As illustrated and described above, the links connect the plurality of nodes, and represent relationships between the nodes or data sources. In step 706, the user may select a node in the three-dimensional representation and upon selection, in step 708, a sub-application is then displayed to the user. The user may input filter parameters for the selected node in the sub-application, as shown in step 709. The software application 001 then updates all search results for the nodes linked to the selected node, as shown in step 710. Alternatively, in step 707, the user may select a link (instead of a node) in the three-dimensional representation to determine the linking relationship between nodes at either end of the selected link.

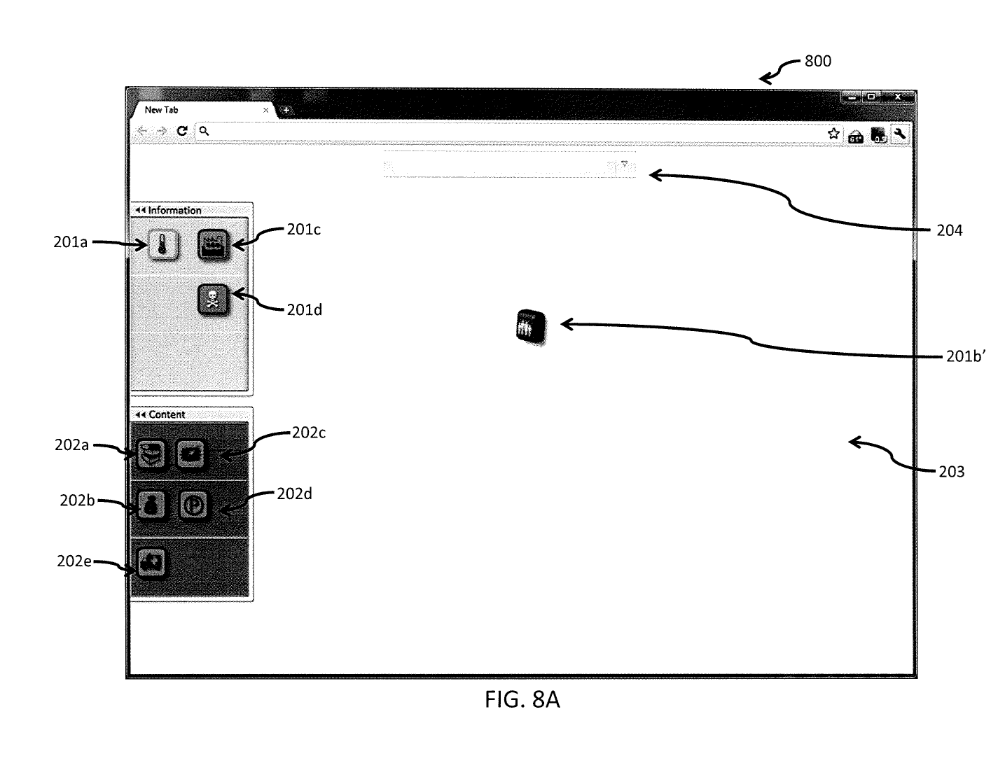

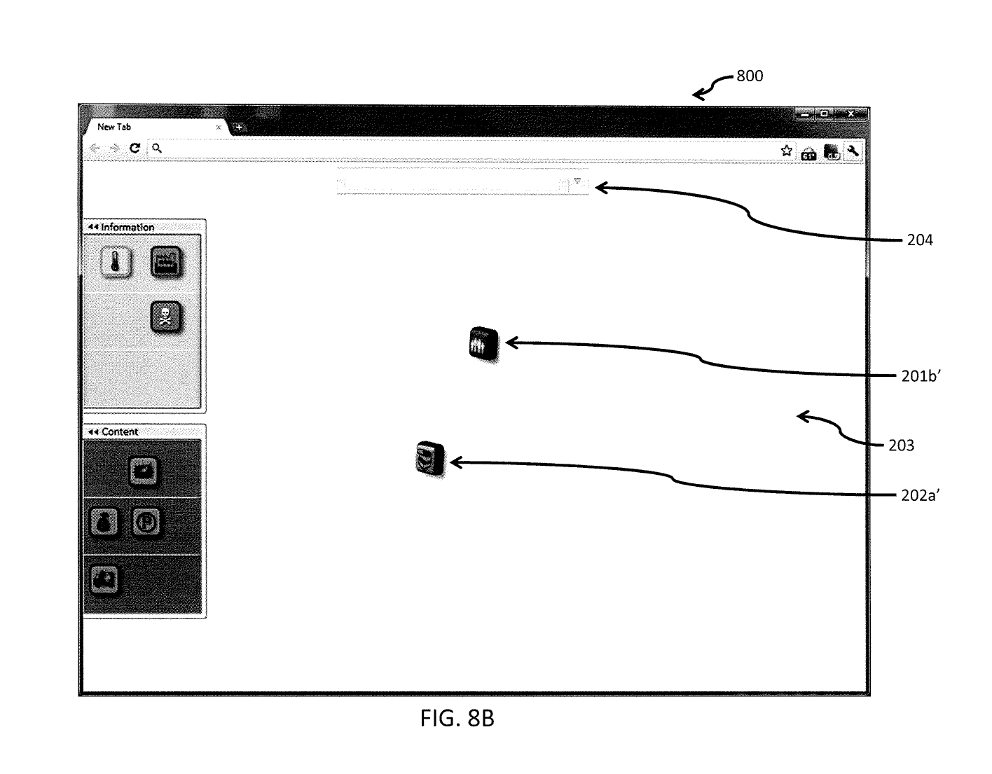

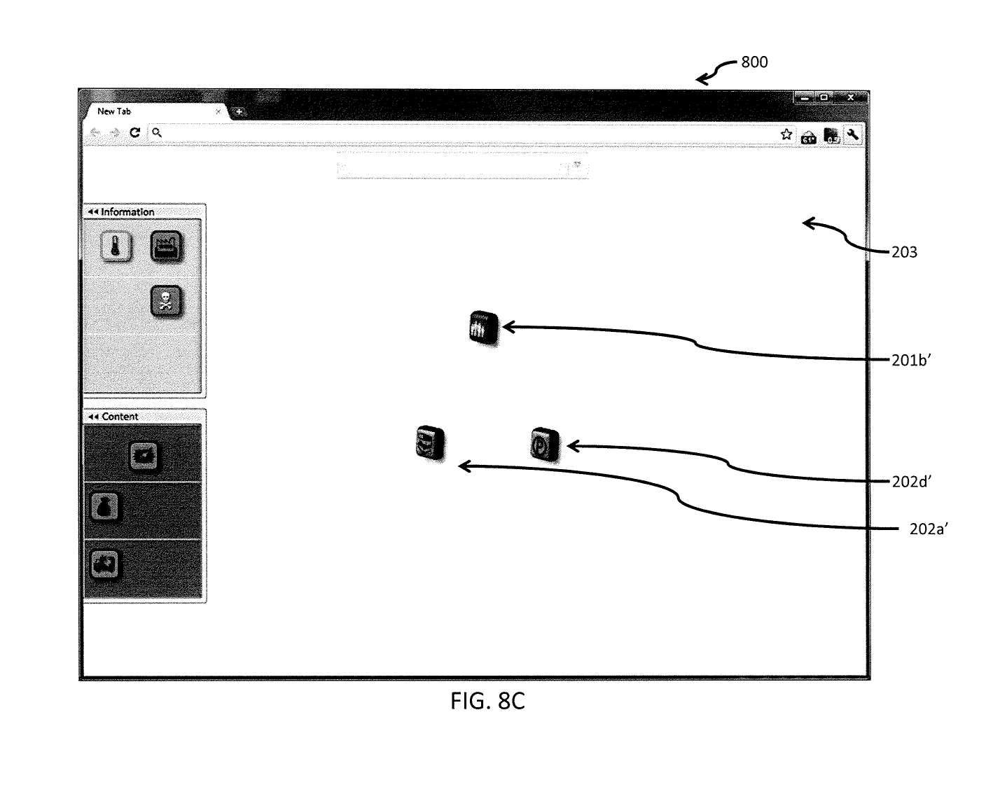

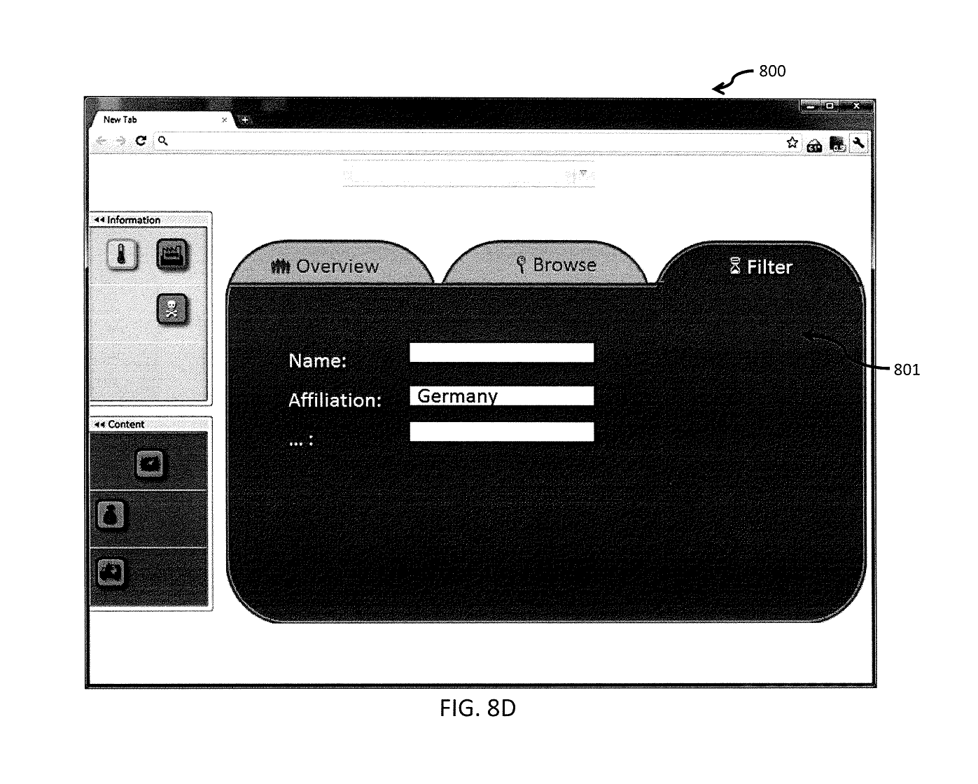

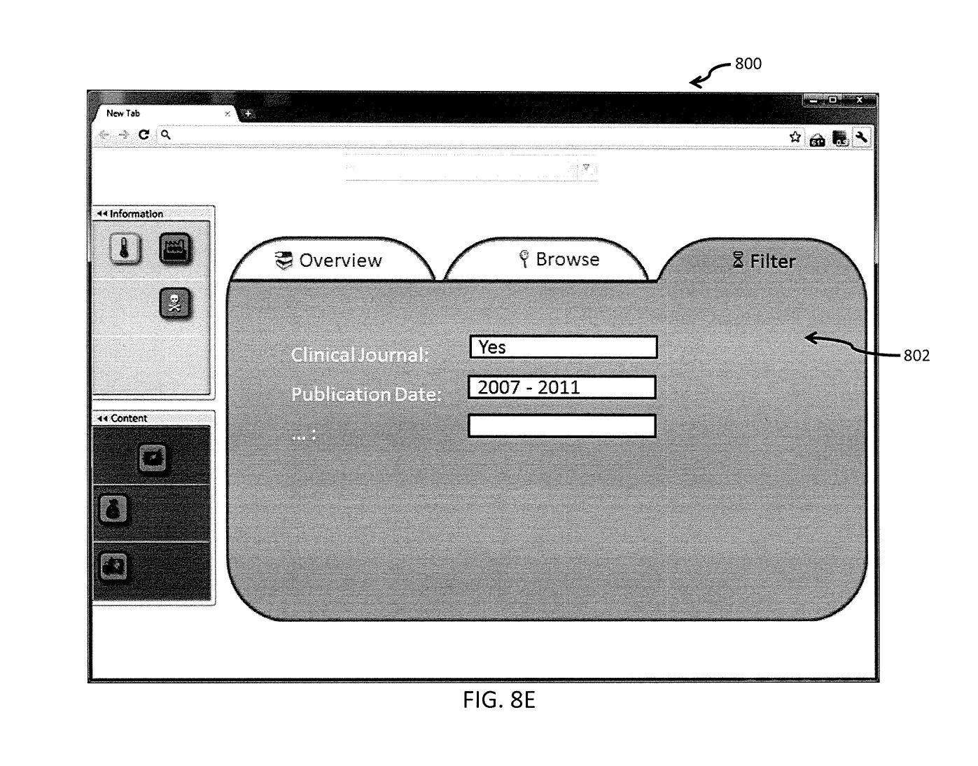

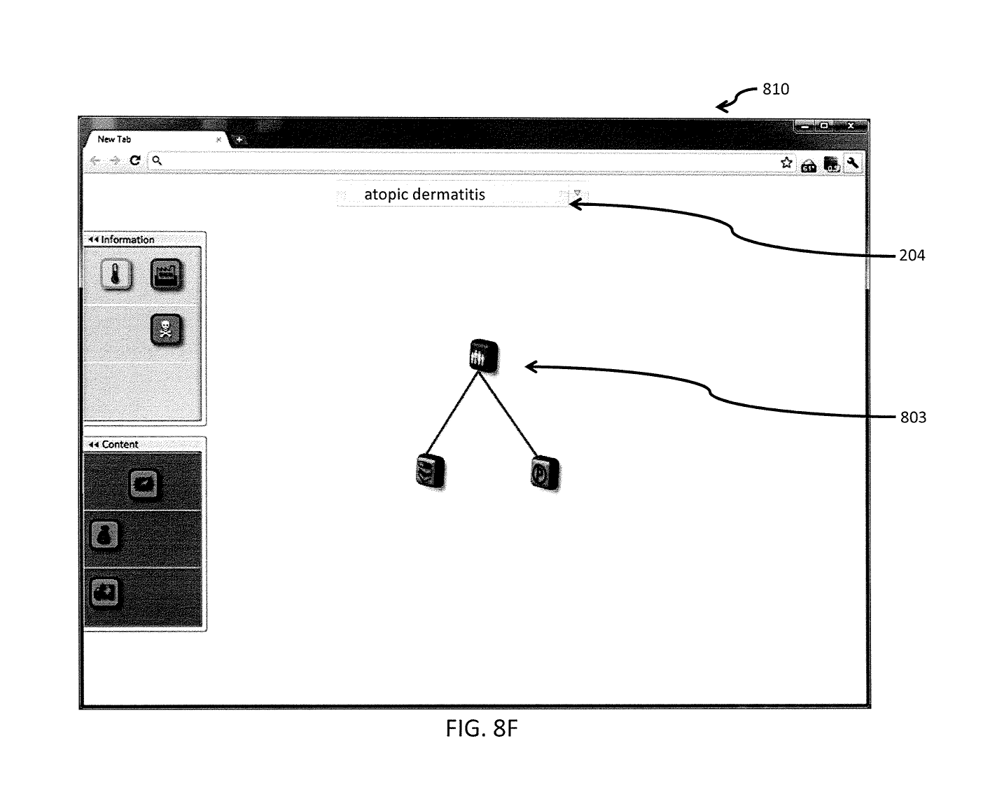

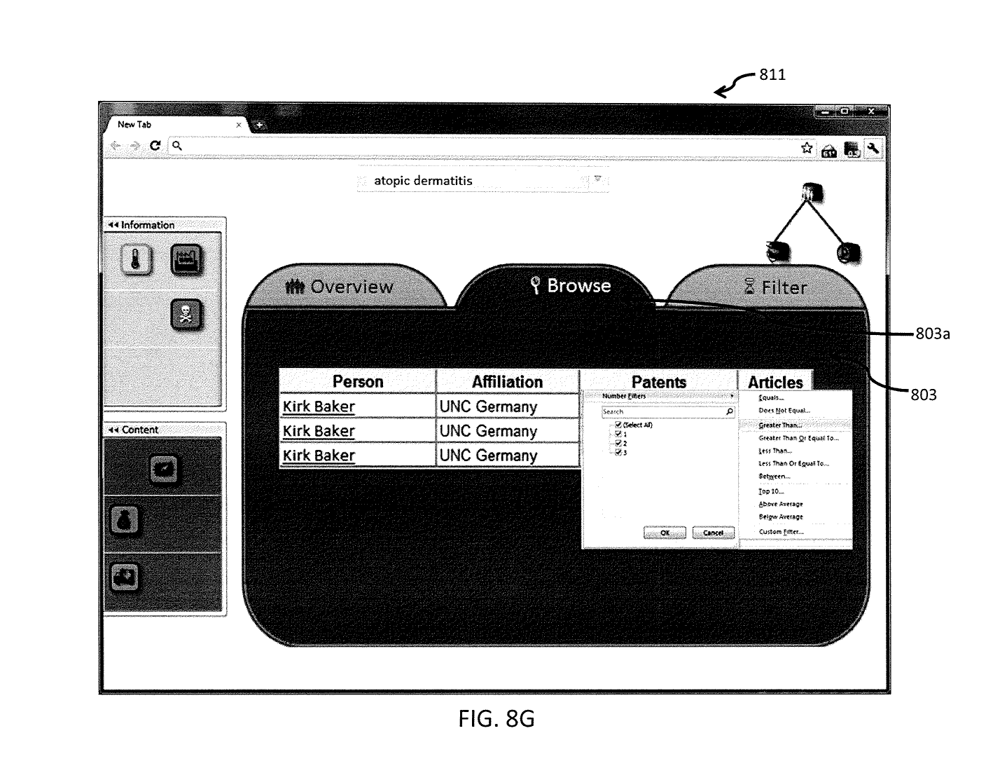

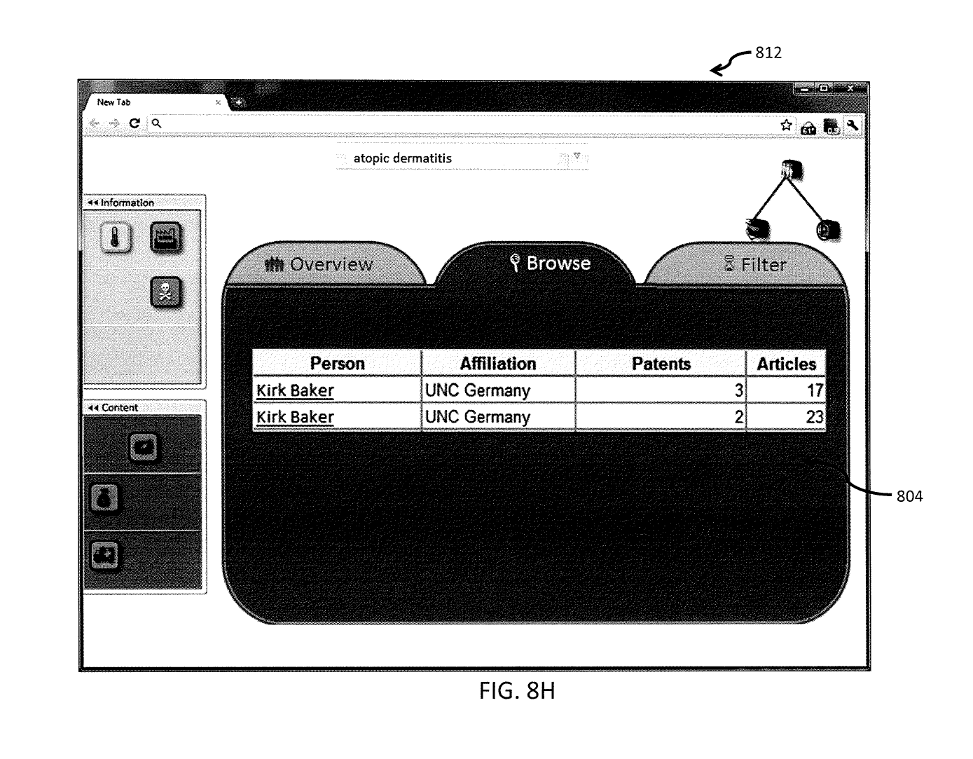

In an alternative operating process, and referring to FIGS. 8A through 8C, a user may drag and drop data sources, including by way of example, People 201b, Medline 202a, and Patent 202d within the workspace 203. The user may select the People data source node 201b′ by clicking it and upon selection, a sub-application 801 is displayed, as shown in FIG. 8D. The user may then specify filtering parameters within the selected sub-application 801, such as name or affiliation. Additionally, the user may also select the Medline data source node 202a′ by clicking it and upon selection, a sub-application 802 is displayed, as shown in FIG. 8E. The user may then specify filtering parameters for that sub-application 802, such as clinical journal or publication date.

Referring to FIG. 8F, the user may enter a search term, such as “atopic dermatitis” in the search query textbox 204. The results page 810 then displays a three-dimensional representation 803 in the workspace 203 for that search term showing the links or connections between the data source nodes. The user may also select the People data source node 201b′ for display of the sub-application 803 and select the Browse tab 803a to view the search results on results page 811, as shown in FIG. 8G. The user may also specify other filtering parameters, such as persons with at least two patents, and the results page 812 then displays the updated results 804, as shown in FIG. 8H.

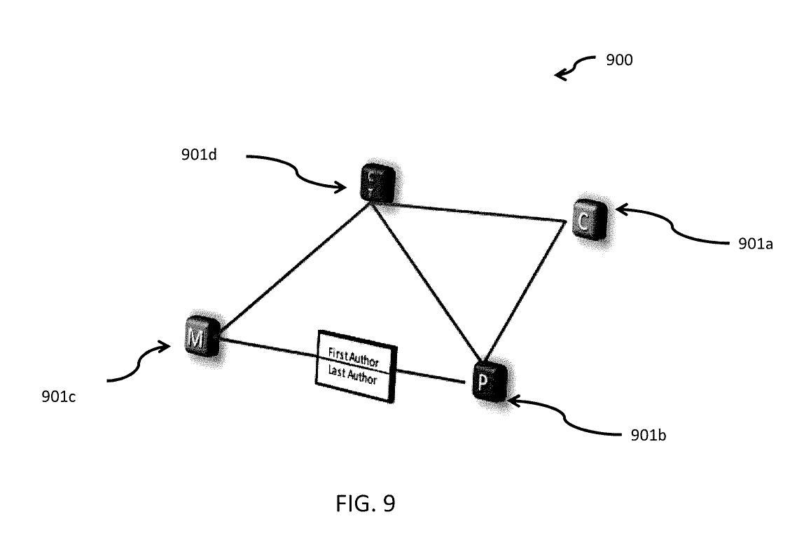

FIG. 9 illustrates a results page interface showing the relationship between the selected data sources. The user may select a link in the three-dimensional representation 900 to determine the linking relationship between data source nodes—in this example being Compounds 901a, Patents 901b, Medline 901c, and Clinical Trials 901d. For example, the user may be interested only in patents (in Patents 901b) by persons who are first authors on the Medline documents (in Medline 901c) that match their selection parameters. Such a selection criteria and filter is easily entered and the results shown using the inventive methodology and system.

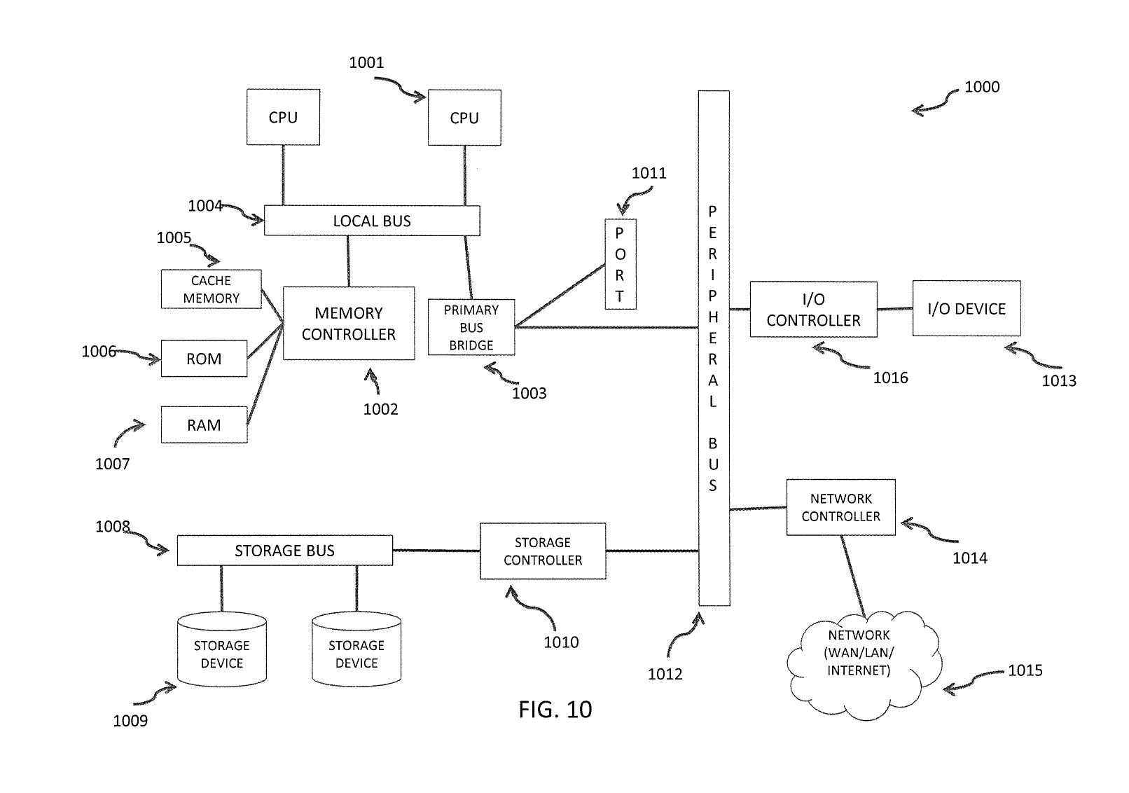

FIG. 10 illustrates a preferred embodiment of the inventive computer system 1000 for implementing the methods in accordance with various embodiments of the invention. The system 1000 includes one or more processors (or central processing units (“CPUs”) 1001 coupled to a local bus 1004. A memory controller 1002 and a primary bus bridge 1003 are coupled to the local bus 1004. The computer system 1000 may include multiple memory controllers 1002 and multiple primary bus bridges 1003. The memory controller 1002 may also be coupled to one or more Read-Only Memory (“ROM”) devices 1006, one or more Random-Access Memory (“RAM”) devices 1007, and a cache memory 1005. In an exemplary embodiment, the cache memory 1005, may be the only cache memory in the computer system 1000. Alternatively, CPUs 1001 may also include independent cache memories, which may form a cache hierarchy with cache memory 1005.

The primary bus bridge 1003 is coupled to at least one peripheral bus 1012. Various devices, such as peripherals or additional bus bridges may be coupled to the peripheral bus 1012. These devices may include a storage controller 1010, an input/output (“I/O”) controller 1016, and a network controller 1014. The primary bus bridge 1012 may also be coupled to one or more ports 1011 including, but not limited to, a parallel communication port, a serial communication port, a universal serial bus, or one or more special purpose high-speed ports. In a personal computer, for example, the special purpose port might be an Accelerated Graphics Port (“AGP”), used to couple a video card to the computer system 1000.

One or more storage devices 1009 may be coupled to a storage bus 1008 which in turn may be coupled to a storage controller 1010. Storage devices 1009 may be internal or external to the computer system 1000 and may include, but not be limited to, hard disk drives, floppy disk drives (“FDD”), optical disks, magneto-optical disks, universal serial bus (“USB”) flash drives or any other type of nonvolatile solid-state storage, memory cards, magnetic tapes, CD-ROMs BD-ROMs, CD-Rs, DVD-Rs, BD-Rs, CD-RWs, DVD+Rs, DVD-RWs, DVD+RWs, DVD-RAM, HD-DVDs, or BD-REs, reader or other similar devices existing or which may be created. I/O device 1013 may be coupled to an I/O controller 1016 which in turn may be coupled to the peripheral bus 1012. The I/O device 1013 may be external or internal to the computer system 1000 and may include, but not be limited to (i) input devices such as wired or wireless keyboards, mouse, trackballs, touch pads, touch screens, pens, joy sticks, microphones, and webcams; and (ii) output devices such as monitors, speakers, and printers.

While FIG. 10 illustrates an architecture especially suitable for a general-purpose computer, such as a personal computer or a workstation, it should be recognized that other known modifications can be made to configure the computer system 1000 to become more suitable for use in a variety of other applications. The modifications may include, for example, elimination of unnecessary components, or addition of specialized devices or circuits, and/or integration of a plurality of devices.

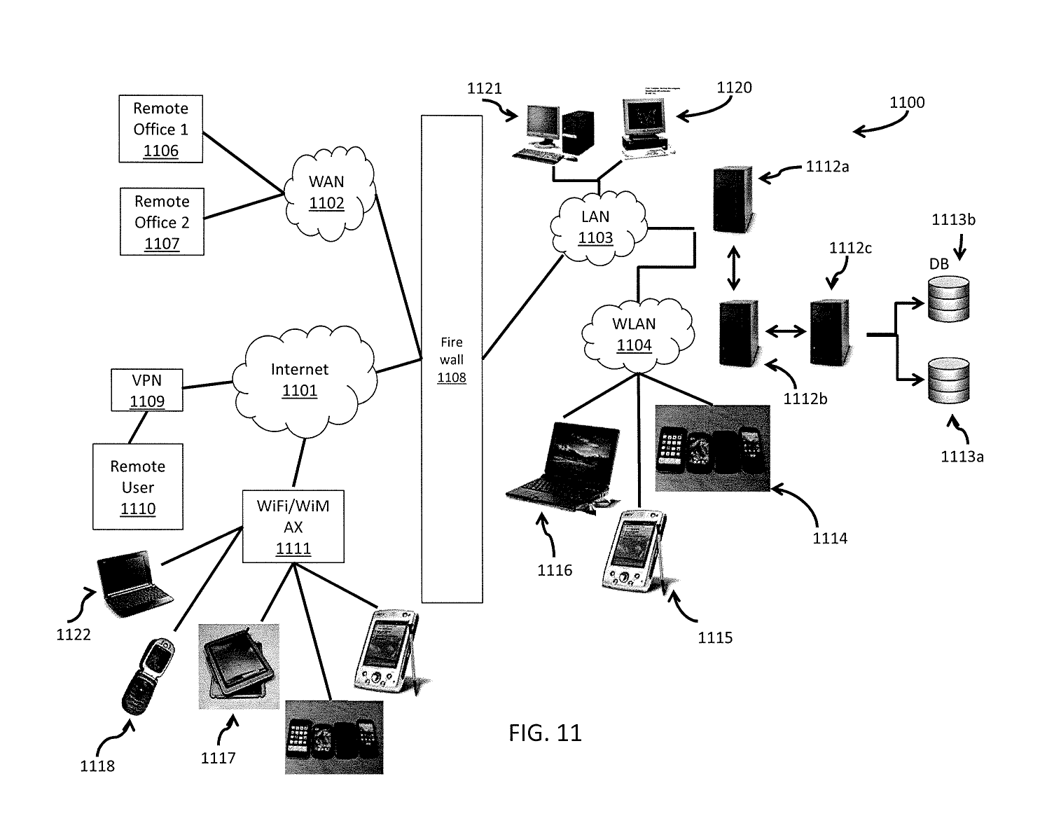

Computer system 1000 may be coupled via a network controller 1014 to an independent network 1015 and may be communicatively linked to other computers via the network 1015. The network 1015 may be a wired network, wireless network, telephone network, packet network, optical network or other similar communications platform. For example, as illustrated in FIG. 11, the network 1015 may be a Local Area Network (“LAN”) 1103, Wide Area Network (“WAN”) 1102, the Internet 1101, a Metropolitan Area Network (“MAN”), a Wireless Local Area Network (“WLAN”), a Storage Area Network/System Area Network (“SAN”), a Campus Area Network (“CAN”) or any other network capable of receiving or sending information.

Computer system 1000 may communicate with network 1015 using connectionless packet switching including, but not limited to, Ethernet, Internet Protocol (“IP”) and User Datagram Protocol (“UDP”) or connection oriented packet switching, for example, X.25, Frame Relay, Asynchronous Transfer Mode (“ATM”), or Multiprotocol Label Switching (“MPLS”). Computer system 1000 may also communicate with network 1015 using wireless networking protocols such as Wi-Fi (e.g., IEEE 802.11a/b/e/g/i/n), WiMAX (e.g., IEEE 802.16) or other similar networking protocols.

By way of one preferred example, FIG. 11 illustrates a distributed architecture in which methods according to various preferred embodiments of the invention may be implemented within a distributed computer system 1100. It should be recognized that several well-known modifications can be made to system 1100 to make the system more suitable for use in a variety of other applications. For example, the distributed architecture may include, but need not be limited to, client-server, 3-tier architecture, n-tier architecture, peer-to-peer, or clustered architecture.

Referring to FIG. 11, a plurality of servers 1112a, 1112b, 1112c may be communicatively linked (e.g., using hardware links, optical links, satellite links, wireless communication links or the like) to a plurality of clients 1120, 1121, 1114, 1115, 1116. The plurality of servers 1112a, 1112b, 1112c and the plurality of clients 1120, 1121, 1114, 1115, 1116 may each be communicatively linked to a network such as LAN 1103, WLAN 1104, an intranet, a private network, a switched network, a wireless network or other types of networks. Further, LAN 1103 may be communicatively linked to a plurality of offices at remote locations—remote office 1 1106, remote office 2 1107—via WAN 1102; or to a plurality of remote users 1110, or to a plurality of mobile devices 1114, 1115, 1117, 1118, 1122 via the Internet 1101. Various communication protocols, for example, transmission control protocol/internet protocol (“TCP/IP”), hypertext transfer protocol (“HTTP”), wireless application protocol (“WAP”), file transfer protocol (“FTP”), internet message access protocol (“IMAP”), or the like, may be used to facilitate communication between the plurality of servers 1112a, 1112b, 1112c and the plurality of clients 1120, 1121, 1114, 1115, 1116, the plurality of mobile devices 1114, 1115, 1117, 1118, 1122, and/or the plurality of remote offices 1106, 1107, or the plurality of remote users 1110.

In a preferred embodiment, the plurality of servers may include, but not be limited to, an application server 1112b, database server 1112c, web server 1112a, print server, mail server, message server, domain name system (“DNS”) server, or a file server. The hardware and software requirements of the plurality of servers vary depending on the server application. A person of ordinary skill in the art would readily understand how to communicatively link the plurality of servers to the plurality of clients via the network.

Application server 1112b may also contain computer hardware including a computer-readable storage medium and software framework to provide an environment in which applications may be executed. Application server 1112b may also host applications such as Microsoft Office, Visual Studio, and Visio. Further, software implementing particular embodiments of the invention may be stored in the computer-readable storage medium of the application server 1112b for execution.

Database server 1112c may be coupled to databases 1113a, 1113b that may be hierarchical, relational, distributed or object-oriented database management systems. Some known examples of database servers include Oracle, DB2, Informix, Ingris, and SQL server.

Web server 1112a may contain computer hardware and/or software to help deliver content that may be accessed through the Internet 1101. Web server 1112a may respond to a user's mobile devices 1114, 1115, 1117, 1118, 1122 hypertext transfer protocol (“HTTP”) request and deliver hypertext markup language (“HTML”) documents including, but not limited to, style sheets and JavaScripts. Some examples of web server products include, but are not limited to, Apache, internet information services (“IIS”), Google web server (“GWS”), IBM HTTP servers. These type of web servers may contain web applications such as Java Development Kit (“JDK”), .NET, WebSphere, or other similar applications.

In a client-server architecture, as shown in FIG. 11, a plurality of servers are communicatively linked to a plurality of clients, which may be mobile devices, or a personal computer such as a desktop computer 1121, a workstation 1120, a laptop 1116, a netbook 1122, a nettop (not shown), or the like. The plurality of clients may be a “thick” client providing rich functionality independent of a server, or a “thin” client that depends heavily on a server for computational needs. Each of the clients may have applications such as a virtual private network (“VPN”) 1109 that enables secure connection of a remote user 1110 to LAN 1103, or a web browser such as Internet Explorer®, Firefox®, Safari, Chrome, or the like to connect to the Internet 1101.

The described various exemplary networks (LAN 1103, WLAN 1104, WAN 1102) may have one of several topologies including, but not limited to, point-to-point, bus, star, ring, tree, mesh and hybrid. The plurality of servers 1112a, 1112b, 1112c, the plurality of clients 1120, 1121 and/or the plurality of networks 1101, 1102, 1103, 1104 may also be communicatively linked using 100Base-T Ethernet, digital subscriber line (DSL), integrated service digital network (ISDN), DS lines, dedicated T1/T3 lines, fiber-optic cables, satellite dish or the like.

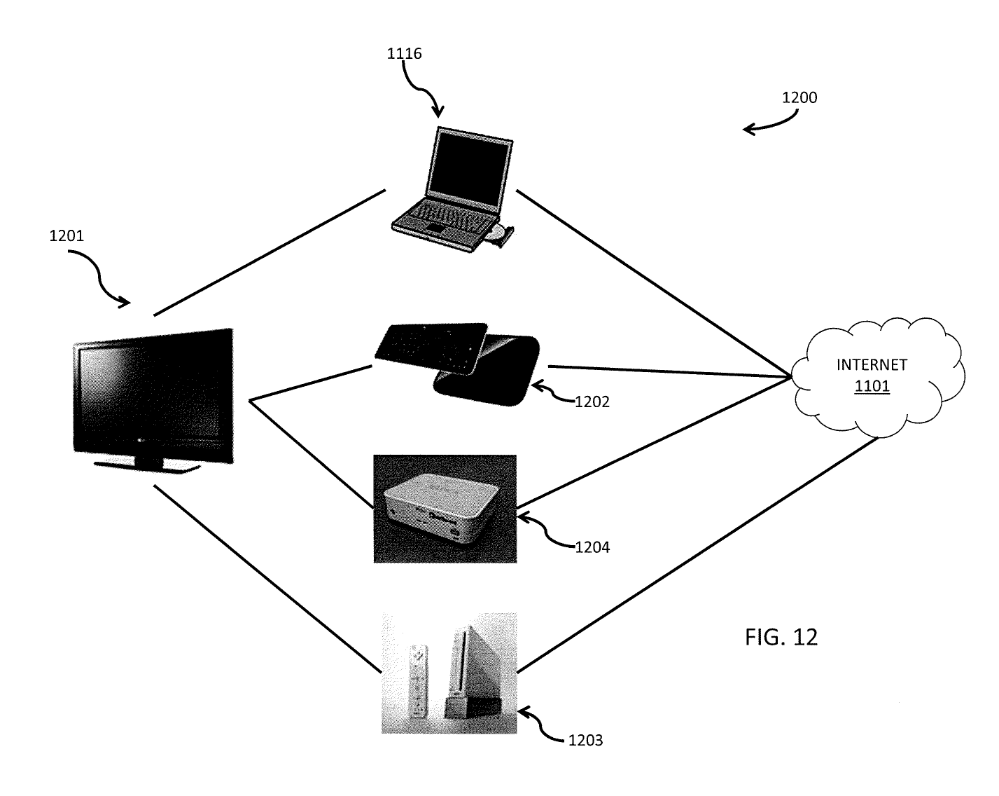

Referring to FIG. 12, an preferred embodiment of a system 1200 that can be used to implement the inventive methodology, includes a television 1201 communicatively linked to the Internet 1101. In such a preferred embodiment, the television 1201 may be coupled to a plurality of devices including, but not limited to, laptop 1116, smart TV device 1202, game console 1203, and/or a set-top box 1204. Smart TV device 1202 provides users with content from TV providers as well as user-generated content using internet applications. Smart TV products currently in the market include, without limitation, Google TV, Samsung Smart TV, Yahoo! Connected TV, or the like.

Set-top box (“STB”) 1204 and game console 1203 may be devices that connect to television 1201 and provide a source of signal enabling display of content on the television screen. For example, game consoles may include, but not be limited to, Nintendo's Wii, Microsoft's Xbox or Sony's PlayStation and set-top boxes may include, but are not limited to, Nokia's Mediamaster, or Motorola's DCT700. While FIG. 12 illustrates a general purpose television, it should be recognized that well known modifications can be made to make it function as an internet TV, web TV, connected TV, smart TV, interactive TV, internet protocol TV, or the like in which methods according to various embodiments of the invention may be readily implemented.

FIG. 13 illustrates an exemplary cloud computing architecture in which methods according to various embodiments of the invention may also be implemented. Referring to FIG. 13, mobile devices 1302, clients (such as netbook 1122, laptop 1116, and desktop 1121), databases 1113b, and data sources (not shown) may be communicatively linked to the cloud 1301. The search engine application 001 may be hosted on the cloud 1301 and be accessed by one or more of the mobile devices 1302, clients 1122, 1116, and/or 1121.

By way of example, and not limitation, the cloud 1301 may be a private cloud, community cloud, combined cloud, hybrid cloud, or any other cloud model. The cloud 1301 may have services such as Software as a Service (“SaaS”), which eliminates the need to install and run an application on a client machine; or as Platform as a Service (“PaaS”), which facilitates a computing platform in the cloud; and/or as Infrastructure as a Service (“IaaS”), which delivers computer infrastructure such as servers, storage and network equipment on the cloud 1301.

The preferred embodiments shown and described in this application have, by way of example, highlighted life sciences searches, but it should be understood that software application 001 is equally applicable and useful in other related and unrelated fields including, but not limited to, engineering, legal, and financial.

While the present invention is described herein with reference to illustrative embodiments for particular applications, it should be understood that the invention is not limited thereto. Those having ordinary skill in the art and access to the teachings provided herein will readily recognize additional modifications, applications, embodiments and substitution of equivalents all of which are understood to be within the scope of the claimed invention. Accordingly, the invention is not to be considered as limited by the foregoing description.

What is claimed is:

1. A method for searching at least one data source, and displaying the results of the search using a computer processor, the method comprising the steps of:
(a) selecting at least one data source to be searched;
(b) entering at least one search term to be used in the search;
(c) processing the search of said at least one data source using said at least one search term;
(d) identifying the data sources that contain a plurality of hits for said search term; and
(e) displaying said hits and search results in a three-dimensional graphical representation using a plurality of nodes and interconnecting links;
wherein said plurality of nodes represent said at least one data source, and said interconnecting links graphically connect said plurality of nodes.

2. The method for searching at least one data source, and displaying the results of the search using a computer processor, as described in claim 1, further wherein the display size of each of said plurality of nodes is proportional to the number of hits within said at least one data source, and color shading of each of said plurality of nodes is a function of relevance of said hits.

3. The method for searching at least one data source, and displaying the results of the search using a computer processor, as described in claim 2, further wherein color shading of each of said plurality of nodes is a function of relevance of said hits.

4. The method for searching at least one data source, and displaying the results of the search using a computer processor, as described in claim 2, further wherein thickness of the interconnecting links between any two nodes in the three-dimensional representation is a function of the search results for the number of results links between said two nodes.

5. The method for searching at least one data source, and displaying the results of the search using a computer processor, as described in claim 1, further comprising the steps of:
(f) selecting one of said plurality of nodes within said three-dimensional representation;
(g) displaying a sub-application menu for said selected one of said plurality of nodes;
(h) entering at least one filter parameters related to selected one of said plurality of nodes; and
(i) updating the search results for all nodes linked to said selected one of said plurality of notes, based upon the entered at least one filter parameters.

6. The method for searching at least one data source, and displaying the results of the search using a computer processor, as described in claim 1, further comprising the steps of:
(f) selecting one of said interconnecting links within said three-dimensional representation;
(g) displaying a sub-application menu for said selected interconnecting link;
(h) entering at least one filter parameters related to selected interconnecting link; and
(i) updating the search results for all nodes connected to said selected interconnecting link, based upon the entered at least one filter parameters.

7. The method for searching at least one data source, and displaying the results of the search using a computer processor, as described in claim 1, wherein the at least one data sources are selected from a group consisting of Medline®, NIH's awarded grants, and AACR conference proceedings.

8. The method for searching at least one data source, and displaying the results of the search using a computer processor, as described in claim 1, wherein the at least one data sources are within the life sciences field.

9. The method for searching at least one data source, and displaying the results of the search using a computer processor, as described in claim 1, wherein the at least one data sources are within the field of engineering.

10. The method for searching at least one data source, and displaying the results of the search using a computer processor, as described in claim 1, wherein the at least one data sources are within the field of legal research.

11. The method for searching at least one data source, and displaying the results of the search using a computer processor, as described in claim 1, wherein the at least one data sources are within the field of financial investing.

12. The method for searching at least one data source, and displaying the results of the search using a computer processor, as described in claim 1, wherein said node shape within the three-dimensional representation is cubical.

13. The method for searching at least one data source, and displaying the results of the search using a computer processor, as described in claim 1, wherein said node shape within the three-dimensional representation is spherical.

14. The method for searching at least one data source, and displaying the results of the search using a computer processor, as described in claim 1, wherein said node shape within the three-dimensional representation is a function of the at least one data source.

15. A computerized system for electronically searching at least one data source, and displaying the results of said search, comprising:
a plurality of computer processors communicatively linked to a plurality of users;
a plurality of memory for storing data, said plurality of memory being communicatively coupled to said at least one of said plurality of computer processors;
a computer-readable storage medium storing a software program with said software program implemented to perform the method steps of:
(a) selecting at least one data source to be searched;
(b) entering at least one search term to be used in the search;
(c) processing the search of said at least one data source using said at least one search term;
(d) identifying the data sources that contain a plurality of hits for said search term; and
(e) displaying said hits and search results in a three-dimensional graphical representation using a plurality of nodes and interconnecting links;
wherein said plurality of nodes represent said at least one data source, and said interconnecting links graphically connect said plurality of nodes.

16. The computerized system for electronically searching at least one data source, and displaying the results of said search, as described in claim 15, wherein the display size of each of said plurality of nodes is proportional to the number of hits within said at least one data source, and color shading of each of said plurality of nodes is a function of relevance of said hits.

17. The computerized system for electronically searching at least one data source, and displaying the results of said search, as described in claim 15, wherein color shading of each of said plurality of nodes is a function of relevance of said hits.

18. The computerized system for electronically searching at least one data source, and displaying the results of said search, as described in claim 15, wherein thickness of the interconnecting links between any two nodes in the three-dimensional representation is a function of the search results for the number of results links between said two nodes.

19. The computerized system for electronically searching at least one data source, and displaying the results of said search, as described in claim 15, further comprising a network controller communicatively connecting said plurality of computer processors to a network.

20. The computerized system for electronically searching at least one data source, and displaying the results of said search, as described in claim 19, wherein said network is selected from a group consisting of a local area network, a wide area network, and the interne.

21. The computerized system for electronically searching at least one data source, and displaying the results of said search, as described in claim 15, wherein remote users access said computerized search and display system through the internet to the cloud.

22. The computerized system for electronically searching at least one data source, and displaying the results of said search, as described in claim 21, wherein said remote users access said computerized search and display system through wireless devices.

23. The computerized system for electronically searching at least one data source, and displaying the results of said search, as described in claim 22, wherein said user wireless devices are selected from a group consisting of laptop computers, smart phones, tablet devices, and televisions.
